(19) United States
(12) Patent Application Publication
(10) Pub. No.: US 2024/0171367 A1
(43) Pub. Date: May 23, 2024

(54) CONFIGURATIONS FOR COMMUNICATIONS WITH MULTIMEDIA TRAFFIC AND TIME DIVISION DUPLEX RESOURCES

(71) Applicant: QUALCOMM Incorporated, San Diego, CA (US)

(72) Inventors: Hyun Yong LEE, San Diego, CA (US); Prashanth Haridas HANDE, San Diego, CA (US); Peerapol TINNAKORNSRISUPHAP, San Diego, CA (US); Mickael MONDET, Louannec (FR); Diana MAAMARI, San Diego, CA (US)

(21) Appl. No.: 18/505,634

(22) Filed: Nov. 9, 2023

Related U.S. Application Data
(60) Provisional application No. 63/383,140, filed on Nov. 10, 2022.

(51) Int. Cl. H04L 5/14; H04W 72/0446; H04W 72/11; H04W 76/28

(52) U.S. Cl. CPC H04L 5/1469; H04W 72/0446; H04W 72/11; H04W 76/28

(57) ABSTRACT

Various aspects of the present disclosure generally relate to wireless communication. In some aspects, a user equipment (UE) may obtain a configuration for an outer configured grant (CG) or semi-persistent scheduling (SPS) cycle with communication times within the outer CG or SPS cycle that are multiples of a time division duplex (TDD) periodicity and that are based at least in part on a multimedia traffic periodicity. The UE may transmit or receive communications at the communication times. Numerous other aspects are described.

### CROSS-REFERENCE TO RELATED APPLICATION

This patent application claims priority to Provisional Patent Application No. 63/383,140, filed on Nov. 10, 2022, entitled “CONFIGURATIONS FOR COMMUNICATIONS WITH MULTIMEDIA TRAFFIC AND TIME DIVISION DUPLEX RESOURCES,” and assigned to the assignee hereof. The disclosure of this prior Provisional application is considered part of and is incorporated by reference into this patent application in its entirety.

### FIELD OF THE DISCLOSURE

Aspects of the present disclosure generally relate to wireless communication and to techniques and apparatuses for configuring communication with multimedia traffic and time division duplex resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining a configuration for an outer configured grant (CG) or semi-persistent scheduling (SPS) cycle with communication times within the outer CG or SPS cycle that are multiples of a time division duplex (TDD) periodicity and that are based at least in part on a multimedia traffic periodicity. The method may include transmitting or receiving communications at the communication times.

Some aspects described herein relate to a method of wireless communication performed by a network entity. The method may include transmitting a configuration for an outer CG or SPS cycle with communication times within the outer CG or SPS cycle that are multiples of a TDD periodicity and that are based at least in part on a multimedia traffic periodicity. The method may include transmitting or receiving communications at the communication times.

Some aspects described herein relate to a method of wireless communication performed by a UE. The method may include receiving a configuration for a periodicity of communication times that are evenly divided by or are multiples of a TDD periodicity and that are based at least in part on a multimedia traffic periodicity. The method may include transmitting or receiving communications at the communication times.

Some aspects described herein relate to a method of wireless communication performed by a network entity. The method may include transmitting a configuration for a periodicity of communication times that are evenly divided by or are multiples of a TDD periodicity and that are based at least in part on a multimedia traffic periodicity. The method may include transmitting or receiving communications at the communication times.

Some aspects described herein relate to a UE for wireless communication. The user equipment may include a memory and one or more processors coupled to the memory. The one or more processors may be configured to obtain a configuration for an outer CG or SPS cycle with communication times within the outer CG or SPS cycle that are multiples of a TDD periodicity and that are based at least in part on a multimedia traffic periodicity. The one or more processors may be configured to transmit or receive communications at the communication times.

Some aspects described herein relate to a network entity for wireless communication. The network entity may include a memory and one or more processors coupled to the memory. The one or more processors may be configured to transmit a configuration for an outer CG or SPS cycle with communication times within the outer CG or SPS cycle that are multiples of a TDD periodicity and that are based at least in part on a multimedia traffic periodicity. The one or more processors may be configured to transmit or receive communications at the communication times.

Some aspects described herein relate to a UE for wireless communication. The user equipment may include a memory and one or more processors coupled to the memory. The one or more processors may be configured to receive a configuration for a periodicity of communication times that are evenly divided by or are multiples of a TDD periodicity and that are based at least in part on a multimedia traffic periodicity. The one or more processors may be configured to transmit or receive communications at the communication times.

Some aspects described herein relate to a network entity for wireless communication. The network entity may include a memory and one or more processors coupled to the memory. The one or more processors may be configured to transmit a configuration for a periodicity of communication times that are evenly divided by or are multiples of a TDD periodicity and that are based at least in part on a multimedia traffic periodicity. The one or more processors may be configured to transmit or receive communications at the communication times.

Some aspects described herein relate to a non-transitory computer-readable medium that stores a set of instructions for wireless communication by a UE. The set of instructions, when executed by one or more processors of the UE, may cause the UE to obtain a configuration for an outer CG or SPS cycle with communication times within the outer CG or SPS cycle that are multiples of a TDD periodicity and that are based at least in part on a multimedia traffic periodicity. The set of instructions, when executed by one or more processors of the UE, may cause the UE to transmit or receive communications at the communication times.

Some aspects described herein relate to a non-transitory computer-readable medium that stores a set of instructions for wireless communication by a network entity. The set of instructions, when executed by one or more processors of the network entity, may cause the network entity to transmit a configuration for an outer CG or SPS cycle with communication times within the outer CG or SPS cycle that are multiples of a TDD periodicity and that are based at least in part on a multimedia traffic periodicity. The set of instructions, when executed by one or more processors of the network entity, may cause the network entity to transmit or receive communications at the communication times.

Some aspects described herein relate to a non-transitory computer-readable medium that stores a set of instructions for wireless communication by a UE. The set of instructions, when executed by one or more processors of the UE, may cause the UE to receive a configuration for a periodicity of communication times that are evenly divided by or are multiples of a TDD periodicity and that are based at least in part on a multimedia traffic periodicity. The set of instructions, when executed by one or more processors of the UE, may cause the UE to transmit or receive communications at the communication times.

Some aspects described herein relate to a non-transitory computer-readable medium that stores a set of instructions for wireless communication by a network entity. The set of instructions, when executed by one or more processors of the network entity, may cause the network entity to transmit a configuration for a periodicity of communication times that are evenly divided by or are multiples of a TDD periodicity and that are based at least in part on a multimedia traffic periodicity. The set of instructions, when executed by one or more processors of the network entity, may cause the network entity to transmit or receive communications at the communication times.

Some aspects described herein relate to an apparatus for wireless communication. The apparatus may include means for obtaining a configuration for an outer CG or SPS cycle with communication times within the outer CG or SPS cycle that are multiples of a TDD periodicity and that are based at least in part on a multimedia traffic periodicity. The apparatus may include means for transmitting or receiving communications at the communication times.

Some aspects described herein relate to an apparatus for wireless communication. The apparatus may include means for transmitting a configuration for an outer CG or SPS cycle with communication times within the outer CG or SPS cycle that are multiples of a TDD periodicity and that are based at least in part on a multimedia traffic periodicity. The apparatus may include means for transmitting or receiving communications at the communication times.

Some aspects described herein relate to an apparatus for wireless communication. The apparatus may include means for receiving a configuration for a periodicity of communication times that are evenly divided by or are multiples of a TDD periodicity and that are based at least in part on a multimedia traffic periodicity. The apparatus may include means for transmitting or receiving communications at the communication times.

Some aspects described herein relate to an apparatus for wireless communication. The apparatus may include means for transmitting a configuration for a periodicity of communication times that are evenly divided by or are multiples of a TDD periodicity and that are based at least in part on a multimedia traffic periodicity. The apparatus may include means for transmitting or receiving communications at the communication times.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of a discontinuous reception (DRX) cycle, in accordance with the present disclosure.

FIG. 5 is a diagram illustrating an example of downlink semi-persistent scheduling (SPS) communication and an example of uplink configured grant (CG) communication, in accordance with the present disclosure.

FIG. 6 is a diagram illustrating an example of CG or SPS communications being misaligned with a multimedia traffic periodicity, in accordance with the present disclosure.

FIG. 7 is a diagram illustrating an example of aligning CG or SPS communications with both a multimedia traffic periodicity and a time division duplex (TDD) pattern, in accordance with the present disclosure.

FIG. 8 is a diagram illustrating an example of CG Type 1 with a TDD pattern, in accordance with the present disclosure.

FIG. 9 is a diagram illustrating an example associated with using communication times that are based on multimedia traffic periodicity and a TDD pattern, in accordance with the present disclosure.

FIGS. 10A and 10B are diagrams illustrating an example of aligning CG or SPS communications with both a multimedia traffic periodicity and a TDD pattern, in accordance with the present disclosure.

FIG. 11 is a diagram illustrating an example of CG Type 2 with a TDD pattern, in accordance with the present disclosure.

FIG. 12 is a diagram illustrating an example of an outer CG or SPS cycle for a TDD pattern, in accordance with the present disclosure.

FIG. 13 is a diagram illustrating an example of extending an outer CG or SPS cycle, in accordance with the present disclosure.

FIGS. 14A-14E are tables illustrating examples of suboptimal configurations for CG or SPS, in accordance with the present disclosure.

FIG. 15 is a diagram illustrating an example process performed, for example, by a UE, in accordance with the present disclosure.

FIG. 16 is a diagram illustrating an example process performed, for example, by a network entity, in accordance with the present disclosure.

FIG. 17 is a diagram illustrating an example process performed, for example, by a UE, in accordance with the present disclosure.

FIG. 18 is a diagram illustrating an example process performed, for example, by a network entity, in accordance with the present disclosure.

FIG. 19 is a diagram of an example apparatus for wireless communication, in accordance with the present disclosure.

FIG. 20 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

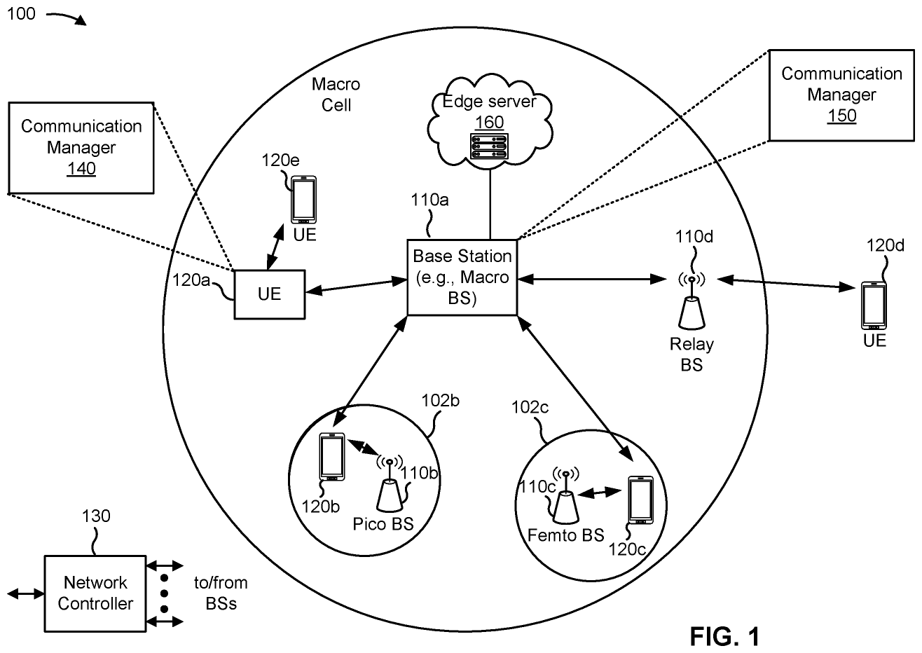

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a UE 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. A network entity may be configured to utilize a protocol stack that is physically or logically distributed among two or more nodes (such as one or more CUs, one or more DUs, or one or more RUs). In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BS s, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may obtain a configuration for an outer configured grant (CG) or semi-persistent scheduling (SPS) cycle with communication times within the outer CG or SPS cycle that are multiples of a time division duplex (TDD) periodicity and that are based at least in part on a multimedia traffic periodicity. The communication manager 140 may transmit or receive communications at the communication times.

In some aspects, the communication manager 140 may receive a configuration for a periodicity of communication times that are evenly divided by or are multiples of a TDD periodicity and that are based at least in part on a multimedia traffic periodicity. The communication manager 140 may transmit or receive communications at the communication times. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration for an outer CG or SPS cycle with communication times within the outer CG or SPS cycle that are multiples of a TDD periodicity and that are based at least in part on a multimedia traffic periodicity. The communication manager 150 may transmit or receive communications at the communication times.

In some aspects, the communication manager 150 may transmit a configuration for a periodicity of communication times that are evenly divided by or are multiples of a TDD periodicity and that are based at least in part on a multimedia traffic periodicity; and transmit or receive communications at the communication times. Additionally, or alternatively, the communication manager 150 may perform one or more other operations described herein.

As indicated above, FIG. 1 is provided as an example. Other examples may differ from what is described with regard to FIG. 1.

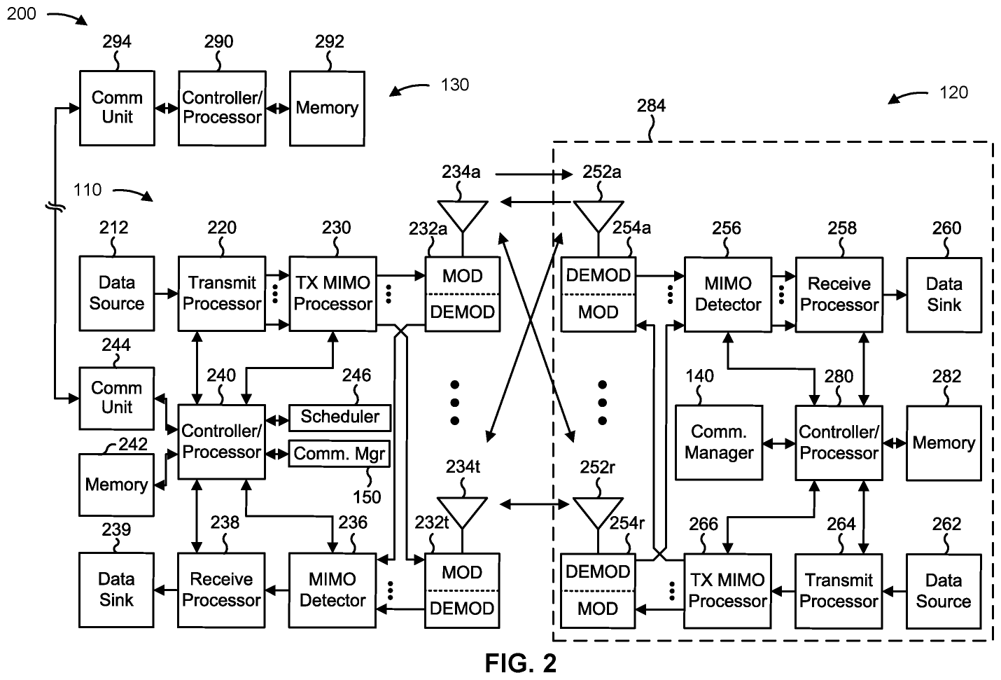

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

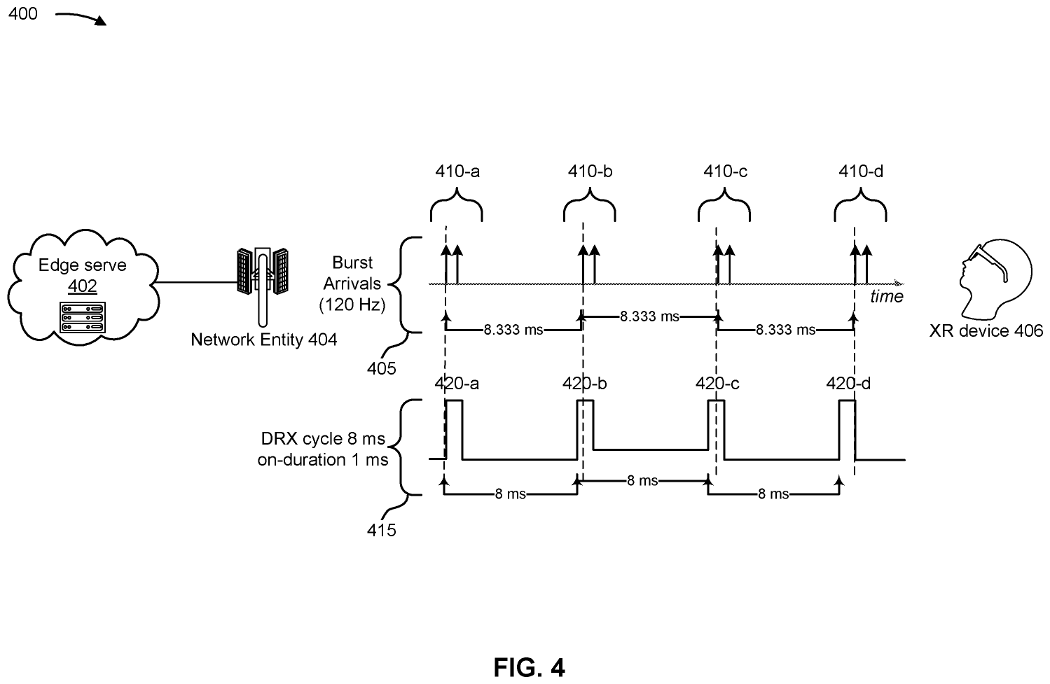

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-20).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-20).

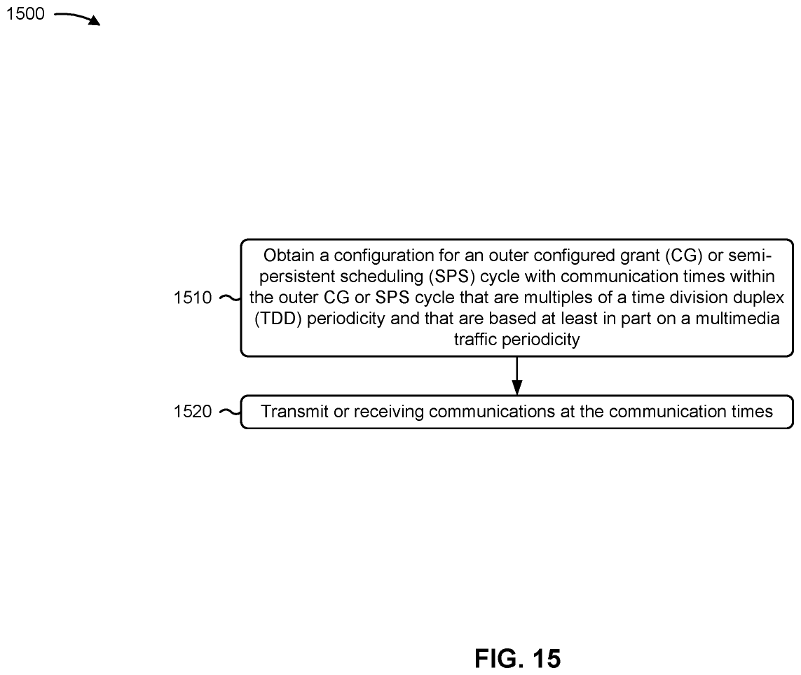

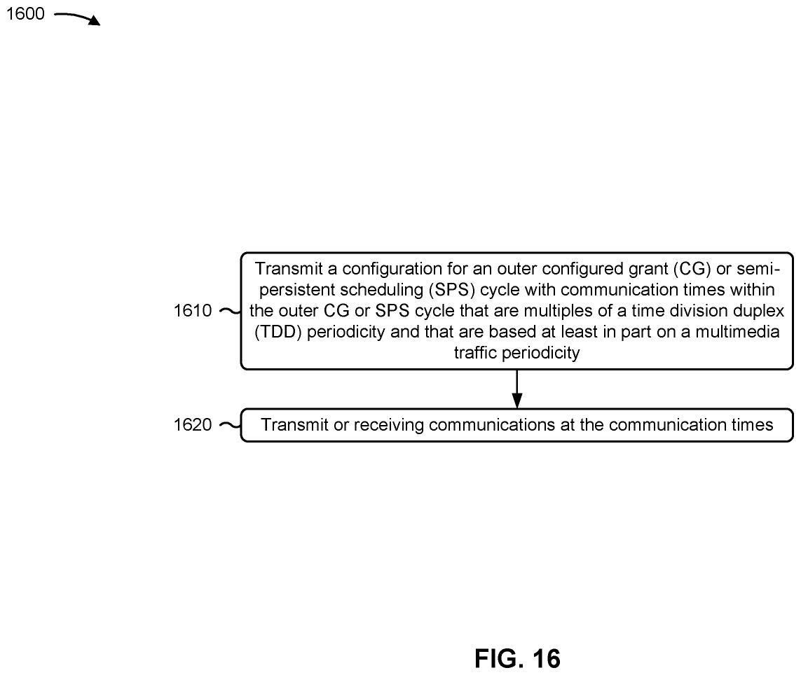

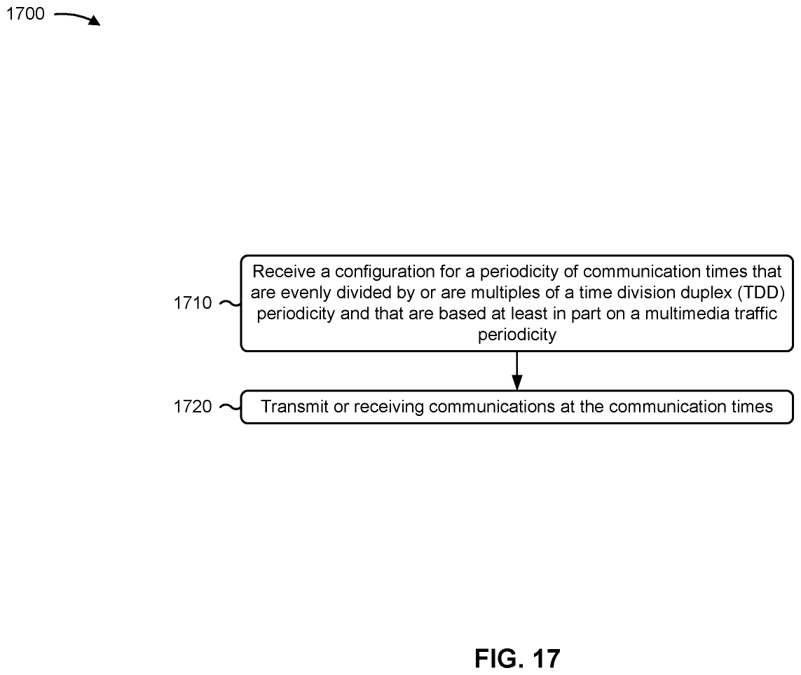

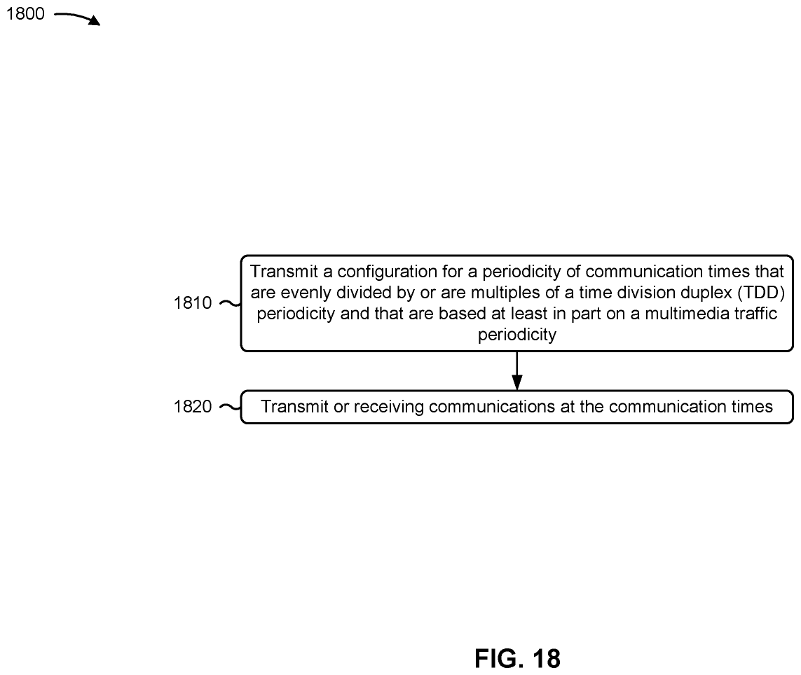

A controller/processor of a network entity (e.g., the controller/processor 240 of the base station 110), the controller/processor 280 of the UE 120, and/or any other component(s) of FIG. 2 may perform one or more techniques associated with configuring communications with a multimedia periodicity and a TDD pattern, as described in more detail elsewhere herein. For example, the controller/processor 240 of the base station 110, the controller/processor 280 of the UE 120, and/or any other component(s) of FIG. 2 may perform or direct operations of, for example, process 1500 of FIG. 15, process 1600 of FIG. 16, process 1700 of FIG. 17, process 1800 of FIG. 18, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1500 of FIG. 15, process 1600 of FIG. 16, process 1700 of FIG. 17, process 1800 of FIG. 18, and/or other processes as described herein. In some examples, executing instructions may include running the instructions, converting the instructions, compiling the instructions, and/or interpreting the instructions, among other examples.

In some aspects, a UE (e.g., UE 120) includes means for obtaining a configuration for an outer CG or SPS cycle with communication times within the outer CG or SPS cycle that are multiples of a TDD periodicity and that are based at least in part on a multimedia traffic periodicity; and/or means for transmitting or receiving communications at the communication times. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a configuration for a periodicity of communication times that are evenly divided by or are multiples of a TDD periodicity and that are based at least in part on a multimedia traffic periodicity; and/or means for transmitting or receiving communications at the communication times.

In some aspects, a network entity (e.g., base station 110) includes means for transmitting a configuration for an outer CG or SPS cycle with communication times within the outer CG or SPS cycle that are multiples of a TDD periodicity and that are based at least in part on a multimedia traffic periodicity; and/or means for transmitting or receiving communications at the communication times. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting a configuration for a periodicity of communication times that are evenly divided by or are multiples of a TDD periodicity and that are based at least in part on a multimedia traffic periodicity; and/or means for transmitting or receiving communications at the communication times.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

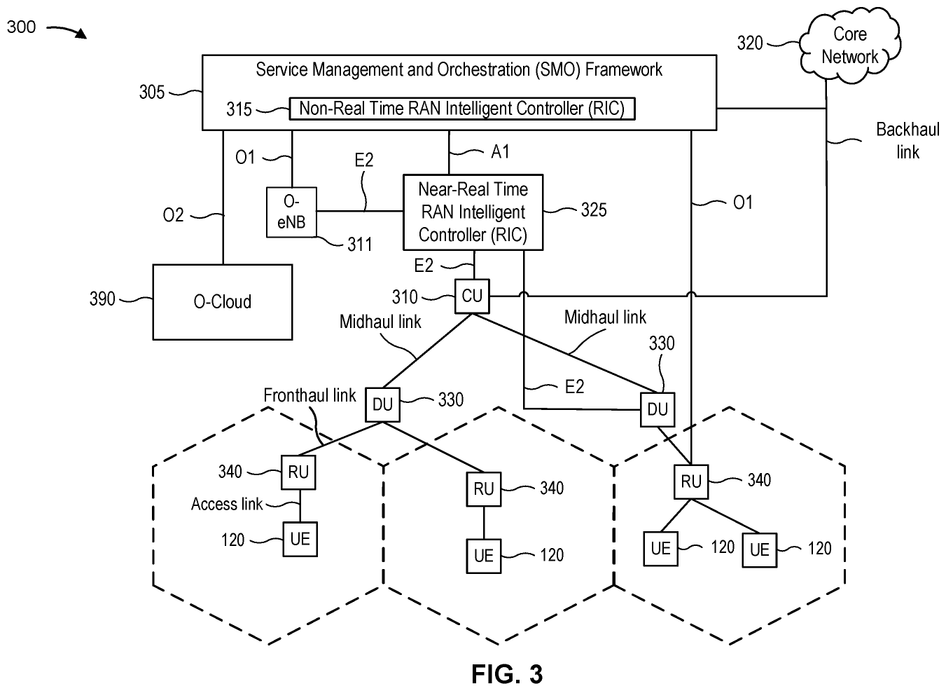

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of a discontinuous reception (DRX) cycle, in accordance with the present disclosure. Example 400 shows the DRX cycle in relation to extended reality (XR) traffic bursts between an edge server 402 (via a network entity 404) to a UE, such as an XR device 406.

Some UEs, including devices for XR, may require low-latency traffic to and from an edge server or a cloud environment. An XR device may be an augmented reality (AR) glass device, a virtual reality (VR) glass device, a gaming device, an educational device, an industrial device, or other devices that provide for AR and/or VR. In one or more examples, a UE, such as an XR device may operate on battery power. The consumption of battery power may be reduced by limiting an amount of time that processing resources of the UE are active for computations and power consumption.

In one or more examples, an XR device 406 (e.g., UE 120) may communicate with an edge server 402 (e.g., edge server 160) or a cloud environment, via a network entity 404 (e.g., base station 110). By offloading some computations to the edge server 402, the XR device 406 may save processing resources. In one scenario, the XR device 406 may split computations for an application with the edge server 402 on the other side of the network entity 404. The edge server 402 may render video frames, such as intra-coded (I) frames and predicted (P) frames, encode the video frames, align the video frames with user pose information, and perform other related computations. However, this means there may be more traffic between the XR device 406 and the edge server 402, which will cause the XR device 406 to consume more power and signaling resources. XR downlink traffic (e.g., video frames) may have a periodic pattern that corresponds to a frame rate of transmitted video data (e.g., H.264/H.265 encoded video).

The XR device 406 may have limited battery capacity while being expected to have a battery life of a smartphone (e.g., full day of use). Battery power is an issue even when the XR device 406 is tethered to a smartphone and uses the same smartphone battery. XR device power dissipation may be limited and may lead to an uncomfortable user experience and/or a short battery life. Power dissipation may be reduced by limiting an amount of time that processing resources of the XR device 406 are active for computations and power consumption. Accordingly, some wireless communication systems may support a DRX mode for the XR device 406 or other UEs.

According to one or more examples, a UE, such as the XR device 406, may conserve power using a DRX mode. A UE in a DRX mode may transition between a sleep state for power conservation and an active state for data transmission and reception. In one or more examples, a UE in a sleep state may turn off a radio and one or more other components or functions of the UE. Turning off or switching off a radio may include removing power from the radio such that the radio is not fully operating or not operating with full power. In one or more examples, a UE may wake up to an active state by turning on a radio and one or more other components or functions of the UE. Other components may include, for example, buffers, timers, memories, and/or processors. Functions of the UE may include, for example, communications, application operations, and/or configurations. Turning on or switching on a radio may include providing power to the radio such that the radio is fully operating (e.g., all applications or functions have sufficient power to execute) and/or operating with full power. As used herein, the active state for data transmission and reception may be referred to as a DRX “ON-duration”.

Traffic (e.g., XR traffic) may have multiple flows of data. An XR flow may include some control information. In an example, such traffic may involve data bursts that are periodic with some time jitter in the arrival. Jitter time may include variations in time of arrival caused by the environment, changes in propagation time, or variations in time introduced by radio components or processors. Furthermore, the packet sizes and the number of packets for a burst may vary from one burst to the next. Additionally, multiple traffic flows can be used for downlink having different periodicities. As such, configuring multiple DRX cycles with different periodicities for multiple flows may cause the UE to be sleeping for less time, which consumes power. Being in an active state consumes power.

A UE, such as the XR device 406, in a DRX mode may transition between a sleep state for power conservation and an active state for data transmission and reception. A UE that uses different DRX cycles (different periods) may have non-uniform cycle durations within a DRX time period. Such non-uniform cycle durations may provide DRX on-durations that are aligned with a periodicity of downlink traffic to the UE. For low-latency applications, the DRX cycle and a start offset of a DRX cycle are to be time-aligned to downlink traffic arrivals.

For example, a UE, such as the XR device 406, may serve the user and enter a brief sleep state in a DRX cycle and between video frames. The XR device 406 and the edge server 402 may attempt to align the uplink and downlink DRX cycles as part of connected DRX (C-DRX), which is DRX operation while the XR device 406 is in an RRC connected state. However, there are DRX-multimedia timing mismatches that prevent such alignment and that prevent successful use of C-DRX.

Example 400 shows, on the top timeline, downlink traffic burst arrivals 405 of XR traffic that may include a number of downlink traffic bursts 410 that are transmitted according to a periodic pattern. Example 400 also shows a DRX configuration 415 on the bottom timeline for a DRX cycle with periodic on-durations at on-duration occasions 420. The downlink traffic bursts 410 may include, for example, XR downlink traffic with a periodic pattern that corresponds to a frame rate of transmitted data (e.g., H.264/H.265 encoded video). An update rate of the XR traffic may be, for example, 120 Hertz (Hz) or 60 Hz, thus resulting in a downlink traffic burst arrival periodicity of 8.333 milliseconds (ms) or 16.667 ms, respectively. The DRX configuration 415 may have on-durations occasions 415-a to 415-d that respectively correspond to downlink traffic bursts 410-a to 410-d.

DRX configurations may have one millisecond as the finest granularity for a DRX cycle, and the start of the on-duration may be aligned to millisecond time boundaries (shown by arrows below the bottom timeline). That is, each on-duration occasion 420 of the DRX cycle is aligned with a millisecond integer value and not a portion of a millisecond. This may result in a partial millisecond difference between a start of a DRX on-duration and a start of a downlink traffic burst of XR traffic. The start of each downlink traffic burst 410 is shown by a dashed line. There may be multiple partial millisecond differences between the start of a downlink traffic burst and a start of a DRX-on duration. For example, the dashed line for the start of downlink traffic burst 410-b does not align with the start of the on-duration occasion 420-b. These partial millisecond differences may compound with each on-duration of a DRX cycle to misalign the DRX cycle and the XR traffic periodicity. For example, the start of the downlink traffic bursts (dashed lines) may drift (increase in the difference) to a middle of an DRX on-duration occasion, as shown by the dashed line for traffic burst 410-c going through the middle of on-duration occasion 420-c. This causes an increase in latency and power consumption.

As indicated above, FIG. 4 is provided as an example. Other examples may differ from what is described with respect to FIG. 4.

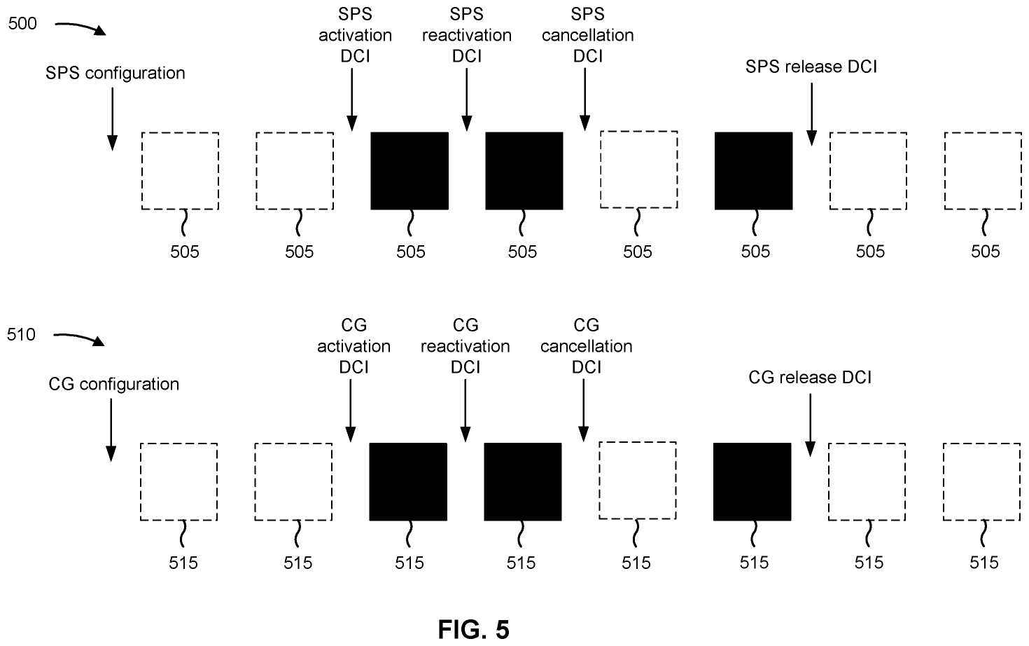

FIG. 5 is a diagram illustrating an example 500 of downlink SPS communication and an example 510 of uplink CG communication, in accordance with the present disclosure. SPS communications may include periodic downlink communications that are configured for a UE, such that a network node does not need to transmit (e.g., directly or via one or more network nodes) separate downlink control information (DCI) to schedule each downlink communication, thereby conserving signaling overhead. CG communications may include periodic uplink communications that are configured for a UE, such that the network node does not need to transmit (e.g., directly or via one or more network nodes) separate DCI to schedule each uplink communication, thereby conserving signaling overhead.

Besides DRX on-durations, CG and SPS communications may also be misaligned with XR traffic periodicity. As shown in example 500, a UE may be configured with an SPS configuration for SPS communications. For example, the UE may receive the SPS configuration via an RRC message transmitted by a network node (e.g., directly to the UE or via one or more network nodes). The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions 505 for the UE. The SPS configuration may also configure hybrid automatic repeat request (HARQ)-acknowledgement (ACK) (HARQ-ACK) feedback resources for the UE to transmit HARQ-ACK feedback for SPS physical downlink shared channel (PDSCH) communications received in the SPS occasions 505. For example, the SPS configuration may indicate a PDSCH-to-HARQ feedback timing value, which may be referred to as a K1 value in a wireless communication standard (e.g., a 3GPP standard).

The network node may transmit SPS activation DCI to the UE (e.g., directly or via one or more network nodes) to activate the SPS configuration for the UE. The network node may indicate, in the SPS activation DCI, communication parameters, such as an MCS, a resource block (RB) allocation, and/or antenna ports, for the SPS PDSCH communications to be transmitted in the scheduled SPS occasions 505. The UE may begin monitoring the SPS occasions 505 based at least in part on receiving the SPS activation DCI. For example, beginning with a next scheduled SPS occasion 505 subsequent to receiving the SPS activation DCI, the UE may monitor the scheduled SPS occasions 505 to decode PDSCH communications using the communication parameters indicated in the SPS activation DCI. The UE may refrain from monitoring configured SPS occasions 505 prior to receiving the SPS activation DCI.

The network node may transmit SPS reactivation DCI to the UE (e.g., directly or via one or more network nodes) to change the communication parameters for the SPS PDSCH communications. Based at least in part on receiving the SPS reactivation DCI, the UE may begin monitoring the scheduled SPS occasions 505 using the communication parameters indicated in the SPS reactivation DCI. For example, beginning with a next scheduled SPS occasion 505 subsequent to receiving the SPS reactivation DCI, the UE may monitor the scheduled SPS occasions 505 to decode PDSCH communications based on the communication parameters indicated in the SPS reactivation DCI.

In some cases, such as when there is not have downlink traffic to transmit to the UE, the network node may transmit SPS cancellation DCI to the UE (e.g., directly or via one or more network nodes) to temporarily cancel or deactivate one or more subsequent SPS occasions 505 for the UE. The SPS cancellation DCI may deactivate only a subsequent one SPS occasion 505 or a subsequent N SPS occasions 505 (where N is an integer). SPS occasions 505 after the one or more (e.g., N) SPS occasions 505 subsequent to the SPS cancellation DCI may remain activated. Based at least in part on receiving the SPS cancellation DCI, the UE may refrain from monitoring the one or more (e.g., N) SPS occasions 505 subsequent to receiving the SPS cancellation DCI. As shown in example 500, the SPS cancellation DCI cancels one subsequent SPS occasion 505 for the UE. After the SPS occasion 505 (or N SPS occasions) subsequent to receiving the SPS cancellation DCI, the UE may automatically resume monitoring the scheduled SPS occasions 505.

The network node may transmit SPS release DCI to the UE (e.g., directly or via one or more network nodes) to deactivate the SPS configuration for the UE. The UE may stop monitoring the scheduled SPS occasions 505 based at least in part on receiving the SPS release DCI. For example, the UE may refrain from monitoring any scheduled SPS occasions 505 until another SPS activation DCI is received by the UE. Whereas the SPS cancellation DCI may deactivate only a subsequent one SPS occasion 505 or a subsequent N SPS occasions 505, the SPS release DCI deactivates all subsequent SPS occasions 505 for a given SPS configuration for the UE until the given SPS configuration is activated again by a new SPS activation DCI.

As shown in example 510, a UE may be configured with a CG configuration for CG communications. For example, the UE may receive the CG configuration via an RRC message transmitted by a network node (e.g., directly to the UE or via one or more network nodes). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 515 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network node may transmit CG activation DCI to the UE (e.g., directly or via one or more network nodes) to activate the CG configuration for the UE. The network node may indicate, in the CG activation DCI, communication parameters, such as an MCS, an RB allocation, and/or antenna ports, for the CG physical uplink shared channel (PUSCH) communications to be transmitted in the scheduled CG occasions 515. The UE may begin transmitting in the CG occasions 515 based at least in part on receiving the CG activation DCI. For example, beginning with a next scheduled CG occasion 515 subsequent to receiving the CG activation DCI, the UE may transmit a PUSCH communication in the scheduled CG occasions 515 using the communication parameters indicated in the CG activation DCI. The UE may refrain from transmitting in configured CG occasions 515 prior to receiving the CG activation DCI.

The network node may transmit CG reactivation DCI to the UE (e.g., directly or via one or more network nodes) to change the communication parameters for the CG PUSCH communications. Based at least in part on receiving the CG reactivation DCI, and the UE may begin transmitting in the scheduled CG occasions 515 using the communication parameters indicated in the CG reactivation DCI. For example, beginning with a next scheduled CG occasion 515 subsequent to receiving the CG reactivation DCI, the UE may transmit PUSCH communications in the scheduled CG occasions 515 based at least in part on the communication parameters indicated in the CG reactivation DCI.

In some cases, such as when the network node needs to override a scheduled CG communication for a higher priority communication, the network node may transmit CG cancellation DCI to the UE (e.g., directly or via one or more network nodes) to temporarily cancel or deactivate one or more subsequent CG occasions 515 for the UE. The CG cancellation DCI may deactivate only a subsequent one CG occasion 515 or a subsequent N CG occasions 515 (where N is an integer). CG occasions 515 after the one or more (e.g., N) CG occasions 515 subsequent to the CG cancellation DCI may remain activated. Based at least in part on receiving the CG cancellation DCI, the UE may refrain from transmitting in the one or more (e.g., N) CG occasions 515 subsequent to receiving the CG cancellation DCI. As shown in example 510, the CG cancellation DCI cancels one subsequent CG occasion 515 for the UE. After the CG occasion 515 (or N CG occasions) subsequent to receiving the CG cancellation DCI, the UE may automatically resume transmission in the scheduled CG occasions 515.

The network node may transmit CG release DCI to the UE (e.g., directly or via one or more network nodes) to deactivate the CG configuration for the UE. The UE may stop transmitting in the scheduled CG occasions 515 based at least in part on receiving the CG release DCI. For example, the UE may refrain from transmitting in any scheduled CG occasions 515 until another CG activation DCI is received by the UE. Whereas the CG cancellation DCI may deactivate only a subsequent one CG occasion 515 or a subsequent N CG occasions 515, the CG release DCI deactivates all subsequent CG occasions 515 for a given CG configuration for the UE until the given CG configuration is activated again by a new CG activation DCI.

As indicated above, FIG. 5 is provided as an example. Other examples may differ from what is described with regard to FIG. 5.

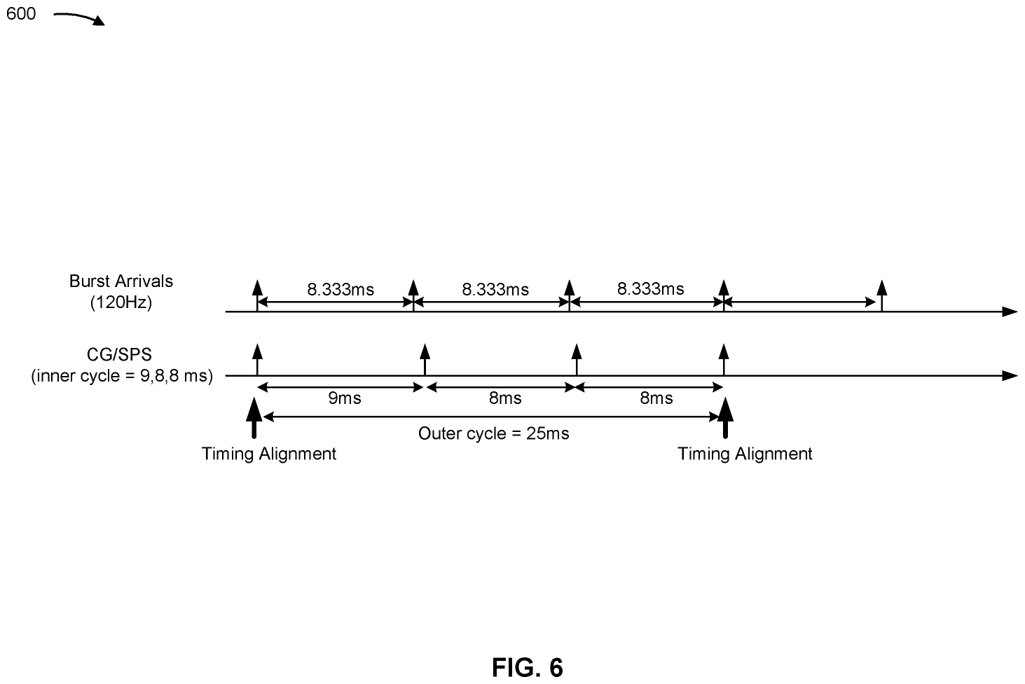

FIG. 6 is a diagram illustrating an example 600 of CG or SPS communications being misaligned with a multimedia traffic periodicity, in accordance with the present disclosure. There may be multiple partial millisecond differences between the start of a downlink traffic burst and a start of a CG occasion or an SPS occasion. These partial millisecond differences may compound with each CG occasion or SPS occasion to misalign the CG occasions or SPS occasions and the XR traffic periodicity. This also causes an increase in latency and power consumption.

Example 600 shows a two-level CG/SPS cycle for XR traffic alignment. An outer CG or SPS cycle supports uniform CG/SPS cycles. The outer CG or SPS cycle may include multiple inner CG or SPS cycles, which can be non-uniform. For example, for 120 frames per second (fps) XR traffic (assuming subcarrier spacing (SCS)=15 kHz, frequency division duplexing (FDD) and no D/U slot restriction), an outer CG or SPS cycle may be 25 ms (indicated by an RRC message). An integer multiple of XR periodicity (i.e., 8.333 ms) can be aligned with CG or SPS periodicity (8.333×3=25). Ideally, the number of inner cycles can be defined as the numerator of an XR periodicity rational number (e.g., 120 fps=25/3 ms). In example 600, the inner CG or SPS cycles=(9,8,8) ms (e.g., in an RRC message, CG/SPS timeDomainOffset={0 ms, 9 ms, 17 ms}). A set of integer inner cycles can make the outer cycle to be aligned with XR traffic periodicity. Ideally, the number of inner cycles can be defined as the denominator of XR periodicity rational number (e.g., 120 fps=25/3 ms).

A rational number periodicity can be configured by any control message, such as RRC signaling, MAC-CE signaling, or DCI signaling. The rational number periodicity can be indicated as one of values which that are defined, or otherwise fixed, by a wireless communication standard, such as the 3GPP (e.g., 120 fps=25/3 ms, 60=50/3 ms, 30=25/3 ms).

While some solutions for aligning CG or SPS with XR traffic periodicity may have been proposed, none of these solutions account for actual TDD patterns. A TDD pattern may be a slot pattern of uplink resources (uplink slot or U), downlink resources (downlink slot or D), and/or special resources (S), which may be guard slots are flexible resources that can be uplink slots or downlink slots. For example, a TDD pattern may be DDDSU. A UE receives downlink communications in D slots, uplink communications in U slots (e.g., especially CG PUSCH communications), and uplink communications or downlink communications in S slots. Without taking into account the TDD pattern used for uplink and downlink resources when aligning with a multimedia (e.g., XR) traffic periodicity, CG or SPS communications (and other types of communications or occasions) cannot be guaranteed to be placed on the appropriate (e.g., granted) U/D resources. This misalignment with the TDD pattern can cause collisions or for some communications to be lost, which wastes power, processing resources, and signaling resources.

As indicated above, FIG. 6 is provided as an example. Other examples may differ from what is described with respect to FIG. 6.

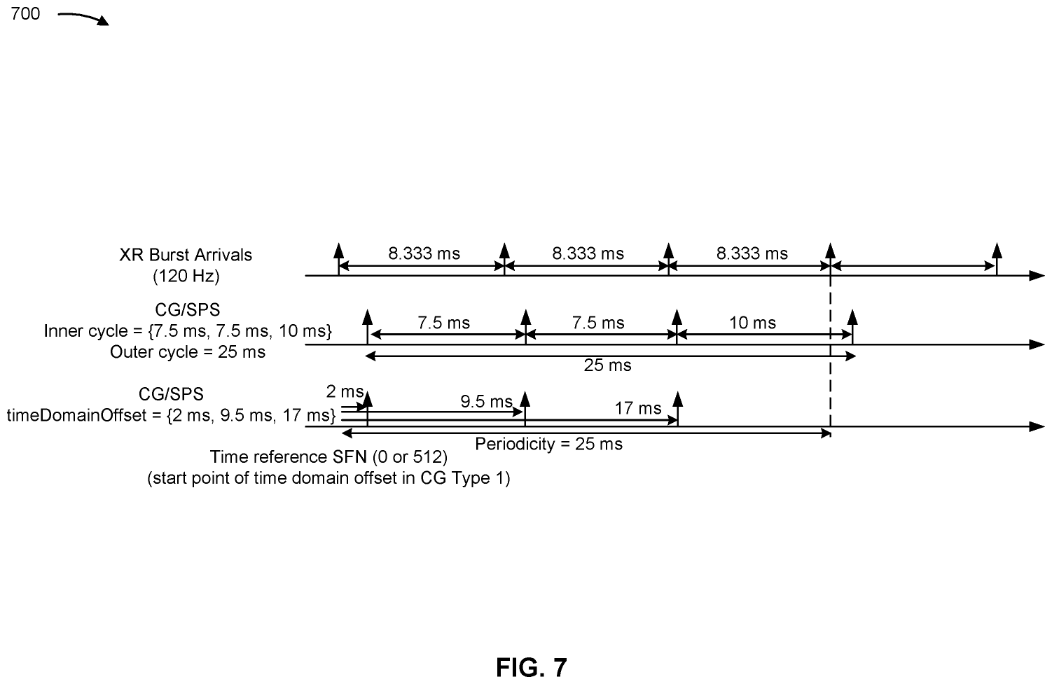

FIG. 7 is a diagram illustrating an example 700 of aligning CG or SPS communications with both a multimedia traffic periodicity and a TDD pattern, in accordance with the present disclosure.

According to various aspects described herein, a UE and the network may align CG or SPS communications with both the multimedia traffic periodicity and the appropriate (e.g., granted) uplink and/or downlink resources of a TDD pattern configured for the UE. For example, a TDD pattern alignment for CG Type-1 (RRC only) may place CG or sounding reference signal (SRS) communication times on U or D resources of TDD pattern, respectively. The UE may be configured to use inner CG or SPS cycles with only a multiple of a TDD periodicity. The sum of the inner CG or SPS cycles may be equal to the outer CG or SPS cycle, so that the CG or SPS communications can be aligned with the XR periodicity. In some aspects, the UE may be configured to use multiple time domain offset (e.g., timeDomainOffset) values for CG or SPS communications on the U or D resources of TDD patterns within the outer CG or SPS cycle that is the nearest to and after an XR burst transmission.

In an example with 120 fps XR traffic, SCS=30 kHz, a TDD Pattern=DDDSU (2.5 ms), and assuming that a PUSCH preparation time of the UE is zero, there may be a configuration for the outer CG or SPS cycle of 25 ms=50 slots=50×14 symbols and the inner CG or SPS cycles of (7.5, 7.5, 10) ms=(15, 15, 20) slots=(15×14, 15×14, 20×14) symbols. With 7.5 ms+7.5 ms+10 ms=25 ms, there is no timing drift. Another configuration with RRC parameters of, for example, a periodicity or time domain offsets for CG type 1 may include a periodicity that equals an outer CG or SPS cycle of 25 ms and time domain offsets of (2 ms, 9.5 ms, 17 ms)=(4, 19, 34) slots=(4×14, 19×14, 34×14) symbols. U resources may only be available at {2 ms, 4.5 ms, 7 ms, 9.5 ms, 12 ms, 14.5 ms, 17 ms, 19.5 ms, 22 ms, 24.5 ms, 25+2 ms, . . . } due to the TDD pattern (e.g., DDDSU) with a periodicity of 2.5 ms. An XR uplink timing may be (0 ms, 8.333 ms, 16.666 ms) with a CG uplink resource timing (2 ms, 9.5 ms, 17 ms, 27 ms). That is, U slots in the TDD pattern may be available at 2 ms, 4.5 ms, 7 ms, 9.5 ms, 12 ms, 14.5 ms, 17 ms, 19.5 ms, 22 ms, 24.5 ms, and 25+2 ms. The UE may use communication times that align closer to periodic multimedia traffic at 2 ms (instead of 0 ms), 9.5 ms (instead of 9 ms), 17 ms, and 27 ms (instead of 25 ms).

As indicated above, FIG. 7 is provided as an example. Other examples may differ from what is described with regard to FIG. 7.

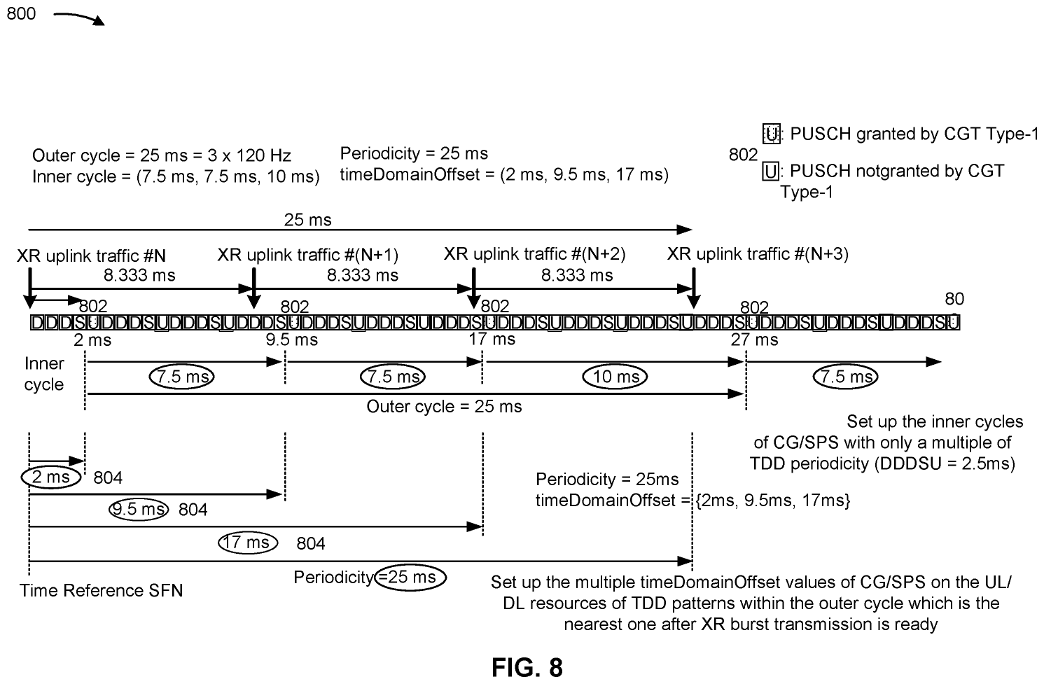

FIG. 8 is a diagram illustrating an example 800 of CG Type 1 with a TDD pattern, in accordance with the present disclosure.

Example 800 shows U slots 802 granted by CG Type 1 with a TDD pattern of DDDSU. In some aspects, the inner CG or SPS cycles of an outer CG or SPS cycle may be set to have communication times that align with the U slots 802 granted by CG Type 1. The inner CG or SPS cycles may be a multiple of TDD periodicity (e.g., 2.5 ms). These U slots 802 may also be nearest to and after XR uplink traffic occasions.

In some aspects, time domain offsets 804 may be set to align with the U slots 802 granted by CG type 1. For example, the time domain offsets 804 may be 2 ms, 9.5 ms, and 17 ms in a periodicity of 25 ms.

As indicated above, FIG. 8 is provided as an example. Other examples may differ from what is described with regard to FIG. 8.

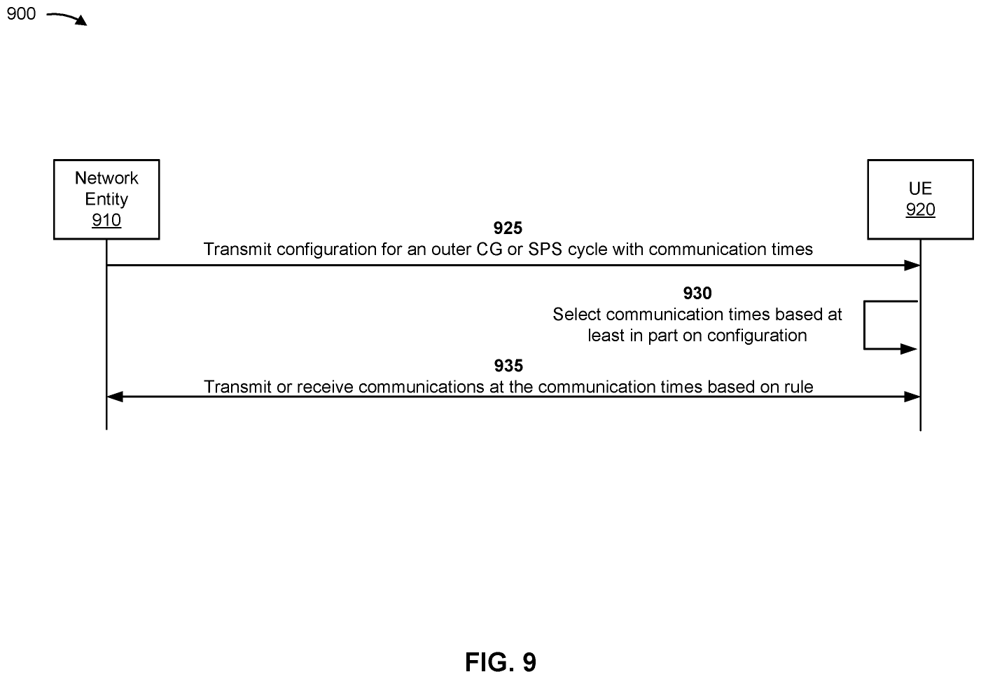

FIG. 9 is a diagram illustrating an example 900 associated with using communication times that are based on multimedia traffic periodicity and a TDD pattern, in accordance with the present disclosure. As shown in FIG. 9, a network entity 910 (e.g., base station 110) and a UE 920 (e.g., UE 120) may communicate with one another on a wireless network (e.g., wireless network 100).

As shown by reference number 925, the network entity 910 may transmit a configuration for an outer CG or SPS cycle with communication times within the outer CG or SPS cycle that are multiples of a TDD periodicity and that are based at least in part on a multimedia traffic periodicity.

As shown by reference number 930, the UE 920 may select communication times based at least in part on the configuration. For example, the UE 920 may select communication times that align (within reasonable distance for quality communications) with the multimedia traffic periodicity, a TDD periodicity, and granted resources of a TDD pattern. The granted resources may be U slots or D slots of CG type 1, CG type 2, or SPS.

As shown by reference number 935, the UE 920 and the network entity 910 may communicate at the communication times. This may include the UE 920 transmitting communications at communication times that align with granted (or scheduled) U slots of a TDD pattern, as shown by example 800 of FIG. 8, or receiving communications at communication times that align with granted or scheduled D slots of the TDD pattern.

By aligning the communication times with the multimedia periodicity and the TDD periodicity, the UE 920 and the network entity 910 may not miss communications due to misalignment. By aligning the communication times with resources of the TDD pattern, the UE 920 and the network entity 910 may further avoid missing communications due to resource mismatches. This improves communications and conserves power, processing resources, and signaling resources.

As indicated above, FIG. 9 is provided as an example. Other examples may differ from what is described with respect to FIG. 9.

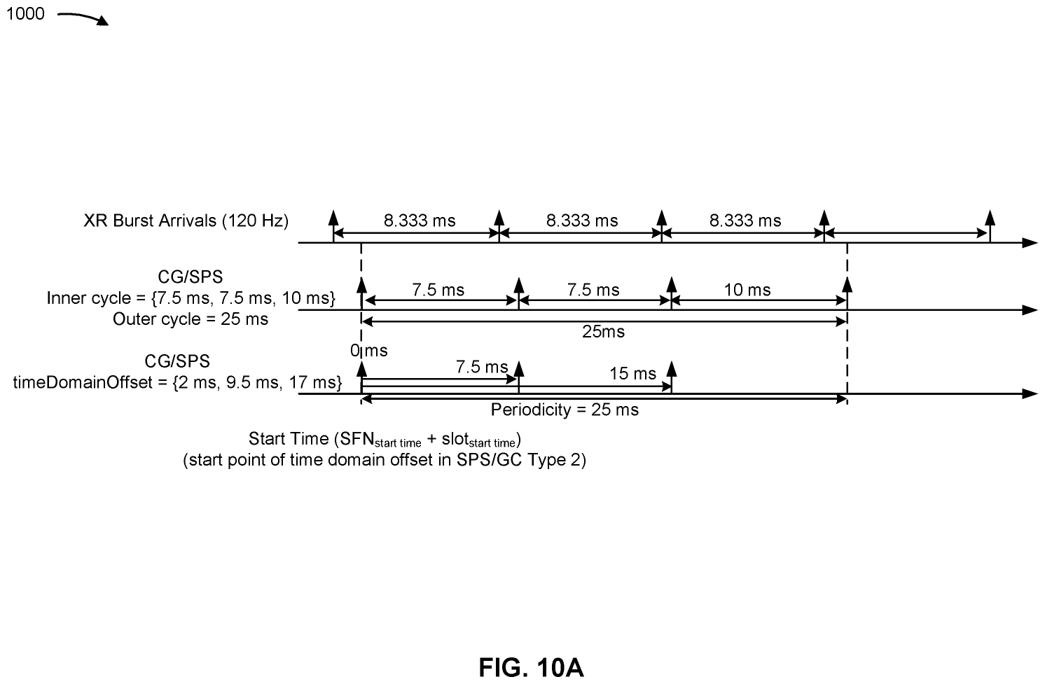

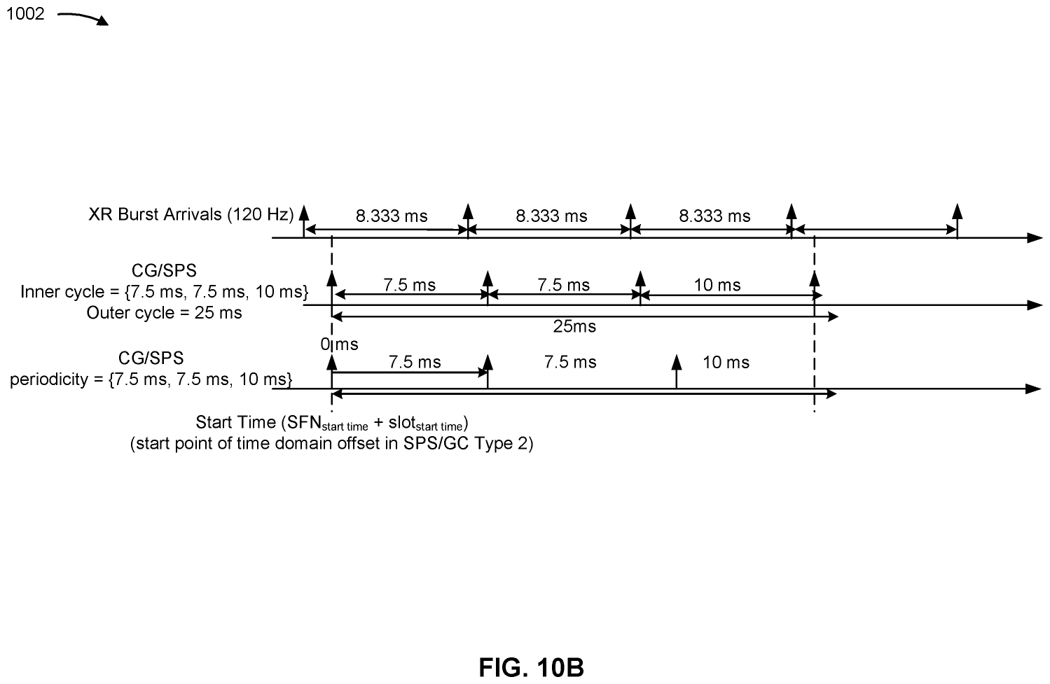

FIGS. 10A and 10B are diagrams illustrating an example 1000 of aligning CG or SPS communications with both a multimedia traffic periodicity and a TDD pattern, in accordance with the present disclosure.

In some aspects, a UE and the network entity may use a TDD pattern alignment for CG Type-2 (RRC and DCI) and place CG or SPS communication times on U or D resources of TDD pattern, respectively. The DCI may dynamically set the start time of CG or SPS. The CG type 2 or SPS configuration may have a periodicity parameter (e.g., rrc-ConfiguredUplinkGrant may be allowed for only CG Type 1). In some aspects, the configuration may further include time domain offset information elements (IEs) for SPS or CG Type 2. The time domain offset IE (e.g., timeDomainOffset IE) or a set of time domain offset IEs, may define the time domain offsets between the start time indicated by DCI and the next CG or SPS communication time within a periodicity. The UE may set up the time domain offsets to place the CG or SPS communication times granted U or D slots of the TDD pattern. If necessary, the network entity 910 may provide the difference values (e.g., delta MCS, delta frequencyDomainAllocation, delta timeDomainAllocation) for each resource of the multiple time domain offsets.

In example 1000 of FIG. 10A with 120 fps XR traffic, SCS=30 kHz, a TDD Pattern=DDDSU (2.5 ms), and assuming that a PUSCH preparation time of the UE is zero, there may be a configuration for the outer CG or SPS cycle of 25 ms=50 slots=50×14 symbols and the inner CG or SPS cycles of (7.5, 7.5, 10) ms=(15, 15, 20) slots=(15×14, 15×14, 20×14) symbols. Another configuration with RRC parameters of, for example, a periodicity or time domain offsets for CG type 2 may include a periodicity that equals an outer CG or SPS cycle of 25 ms and time domain offsets of (0 ms, 7.5 ms, 15 ms)=(0, 15, 30) slots=(0×14, 15×14, 30×14) symbols. The DCI may be associated with a configured scheduling radio network temporary identifier (CS-RNTI) and may grant the initial PUSCH (start time) at 2 ms. A time domain offset value of 0 may indicate an initial PUSCH communication (not explicitly signaled in an RRC message).

In some aspects, the network entity may introduce a set of multiple non-uniform periodicities (e.g., multiple periodicity) for SPS or CG Type 2. In a current standard, the periodicity of CG or SPS can be configured with a single uniform value. By defining the periodicity of CG or SPS with a set of multiple non-uniform values (e.g., SEQUENCE), the CG or SPS configuration can be aligned with the multimedia periodicity. In example 1002 of FIG. 10B, the set of periodicities may be configured with the same values of the set of inner cycles. Therefore, the periodicity for multimedia burst arrivals of 120 Hz may be expected to be (7.5, 7.5, 10) ms=(15, 15, 20) slots=(15×14, 15×14, 20×14) symbols.

In some aspects, the network entity may introduce a new IE that can configure a set of associated CG or SPS configurations for SPS or CG Type 2. In this case, a single DCI with a CS-RNTI may activate/deactivate all the associated CG or SPS configurations along with the current CG or SPS configuration. In FIG. 10A, the first CG configuration has a timedomainoffset of 0 ms, and the second CG configuration has timedomainoffset of 7.5 ms, and the third CG configuration has a timedomainoffset of 15 ms. The configurations may be associated with an RRC message. As a result, a single DCI with a CS-RNTI may grant an initial PUSCH (e.g., start time) at 2 ms and may activate all three CG configurations.

As indicated above, FIGS. 10A and 10B are provided as examples. Other examples may differ from what is described with regard to FIGS. 10A and 10B.

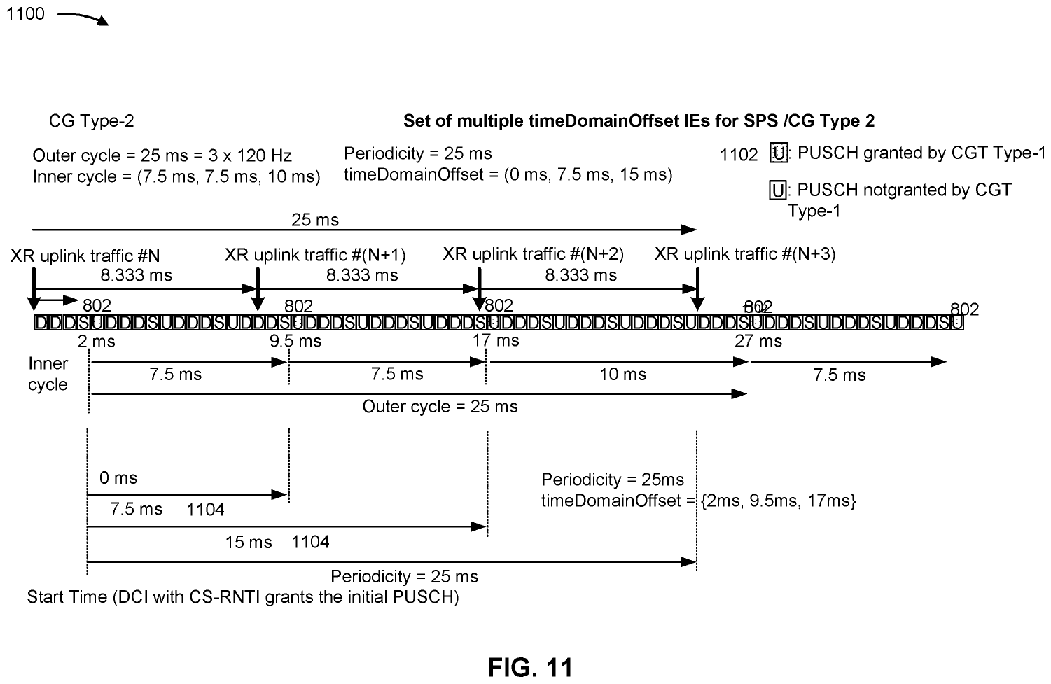

FIG. 11 is a diagram illustrating an example 1100 of CG Type 2 with a TDD pattern, in accordance with the present disclosure.

Example 1100 shows U slots 1102 granted by CG Type 2 with a TDD pattern of DDDSU. In some aspects, the inner CG or SPS cycles of an outer CG or SPS cycle may be set to have communication times that align with the U slots 1102 granted by CG Type 2. The inner CG or SPS cycles may be a multiple of TDD periodicity (e.g., 2.5 ms). These U slots 1102 may also be nearest to and after XR uplink traffic occasions.

In some aspects, time domain offsets 1104 may be set to align with the U slots 1102 granted by CG type 2. For example, the time domain offsets 1104, after a start time indicated by DCI, may be 7.5 ms and 15 ms in a periodicity of 25 ms.

As indicated above, FIG. 11 is provided as an example. Other examples may differ from what is described with regard to FIG. 11.

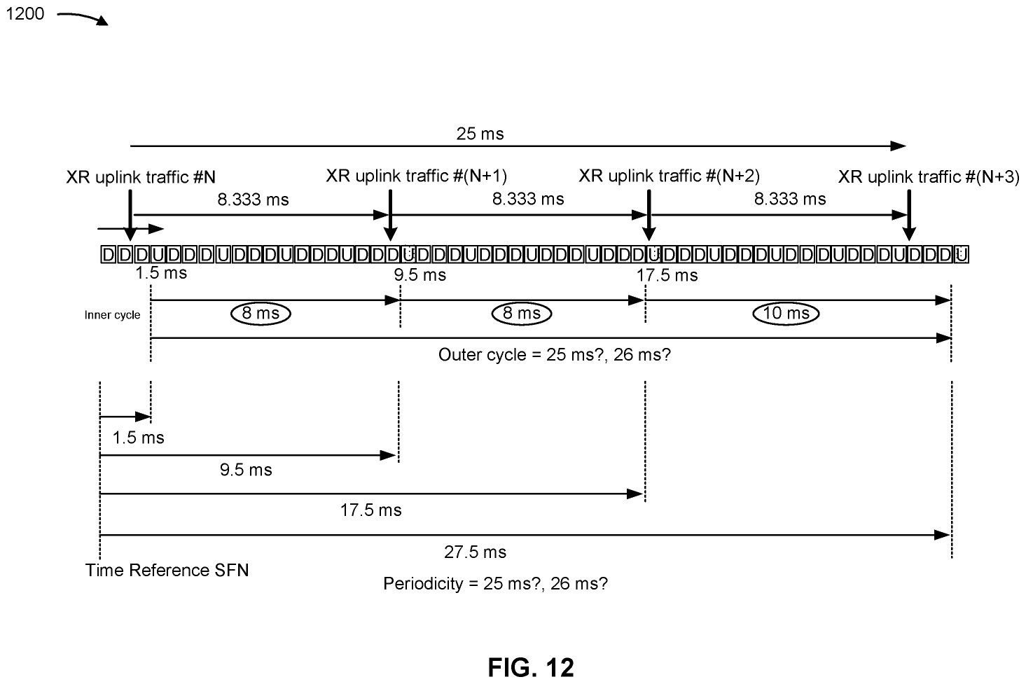

FIG. 12 is a diagram illustrating an example 1200 of an outer CG or SPS cycle for a TDD pattern, in accordance with the present disclosure.

Example 1200 shows granted U slots in a TDD pattern of DDDU (TDD periodicity 2 ms). In some scenarios, the outer CG or SPS cycle may not be able to align with a TDD periodicity. For example, the sum of the inner CG or SPS cycles may be 8 ms+8 ms+10 ms=26 ms, which does not align with the 25 ms of the outer CG or SPS cycle.

As indicated above, FIG. 12 is provided as an example. Other examples may differ from what is described with regard to FIG. 12.

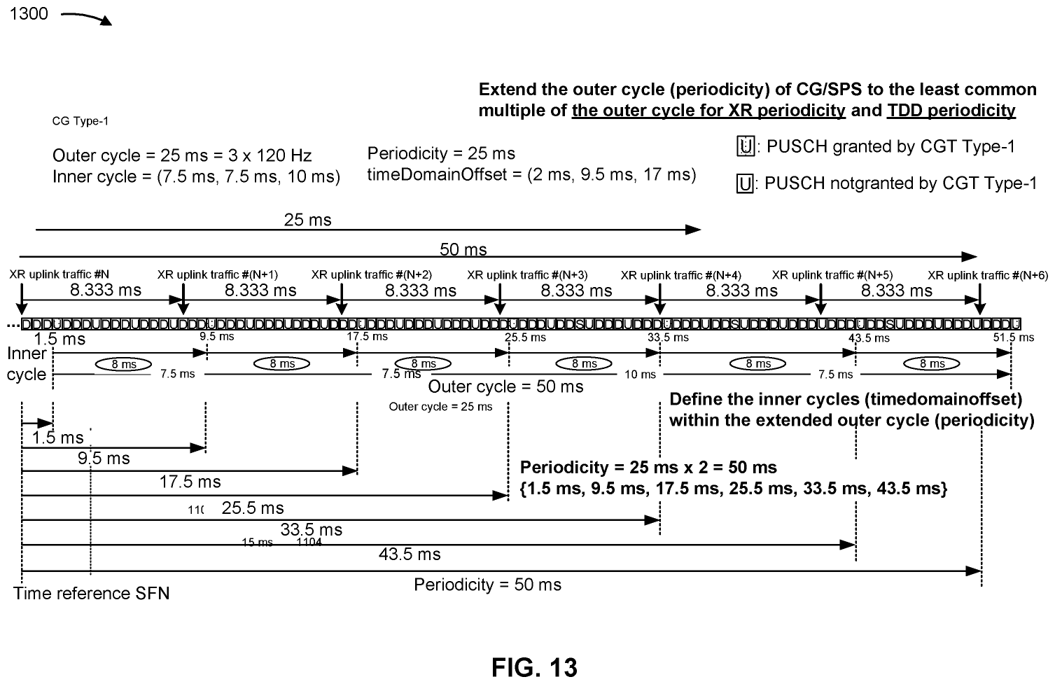

FIG. 13 is a diagram illustrating an example 1300 of extending an outer CG or SPS cycle, in accordance with the present disclosure.

In some aspects, the outer CG or SPS cycle may be extended to align with a TDD periodicity and to align with resources in a TDD pattern. For example, the outer CG or SPS cycle may be extended to 50 ms, which is a multiple of both the XR periodicity and the TDD periodicity. The communication times may also be aligned with granted resources of the TDD pattern.

As indicated above, FIG. 13 is provided as an example. Other examples may differ from what is described with regard to FIG. 13.

In some aspects, a network entity may select an optimum CG or SPS configuration (e.g., periodicity, time domain offsets) for the combination of multimedia traffic and a TDD pattern. The selection may be based at least in part on an algorithm with the following steps. First, find the minimum n which can satisfy that ‘n*XR Periodicity’ is divided by TDD periodicity. Second, set the outer cycle (periodicity)=n*XR Periodicity. Third, sequentially calculate the next XR burst arrival time based on its initial burst arrival time and periodicity. Fourth, find the available downlink (e.g., SPS) or uplink (e.g., CG) resource in a TDD pattern which is earliest after XR burst arrival time of the third step. Fifth, save the resource timing of the third step in the set of inner cycles (timeDomainOffset). Sixth, steps 2-5 may be repeated until all the CG/SPS resources within an outer cycle are allocated. Seventh, the inner cycle (timeDomainOffset) of the fifth step may provide the optimal CG/SPS configuration.

In some aspects, if the network entity has information for the burst arrival of multimedia traffic, the network entity may find the optimal CG/SPS resources by running the proposed algorithm and configuring the UE with the optimal configuration. Time-sensitive communication assistance information (TSCAI) may indicate the burst arrival time from an application function to the network entity. An enhanced TSCAI (eTSCAI) may indicate the multimedia traffic pattern—periodicity (Hz or fps for XR cadence), size, and/or burst arrival time per flow. However, the UE may know the uplink traffic pattern better than the server, and the UE may directly indicate the burst arrival time of uplink traffic based at least in part on a 5G system time. Since the 5G system time is synchronized between the network entity and the UE, the UE may translate the uplink traffic timing of a multimedia (e.g., XR) application into the 5G system time. The UE may provide the burst arrival time of uplink traffic to the network entity. In some aspects, UE assistance information (UAI) may indicate the periodicity (Hz or fps for XR cadence), size (e.g., average, min/max, variance) and burst arrival time (e.g. μs from a certain 5G system reference time or specific slot/subframe/slot) of uplink multimedia traffic flows. Since the uplink traffic may include multiple flows, this traffic pattern can be informed for each flow. Also, a new RRC or MAC CE may be introduced to indicate the uplink traffic pattern instead of the UAI.

In some aspects, the UE may request the relative shift of the current CG/SPS resources for uplink traffic with a UAI or a MAC CE. In the opposite direction, the network entity may request the relative shift of uplink traffic to the UE.

In some aspects, the UE may provide the traffic pattern of downlink traffic with a UAI. The burst arrival time may also be indicated based at least in part on the 5G system time (e.g., μs from a certain 5G system reference time or specific slot/subframe/slot). Also, a new RRC message or MAC CE may be introduced to indicate the downlink traffic pattern instead of the UAI.

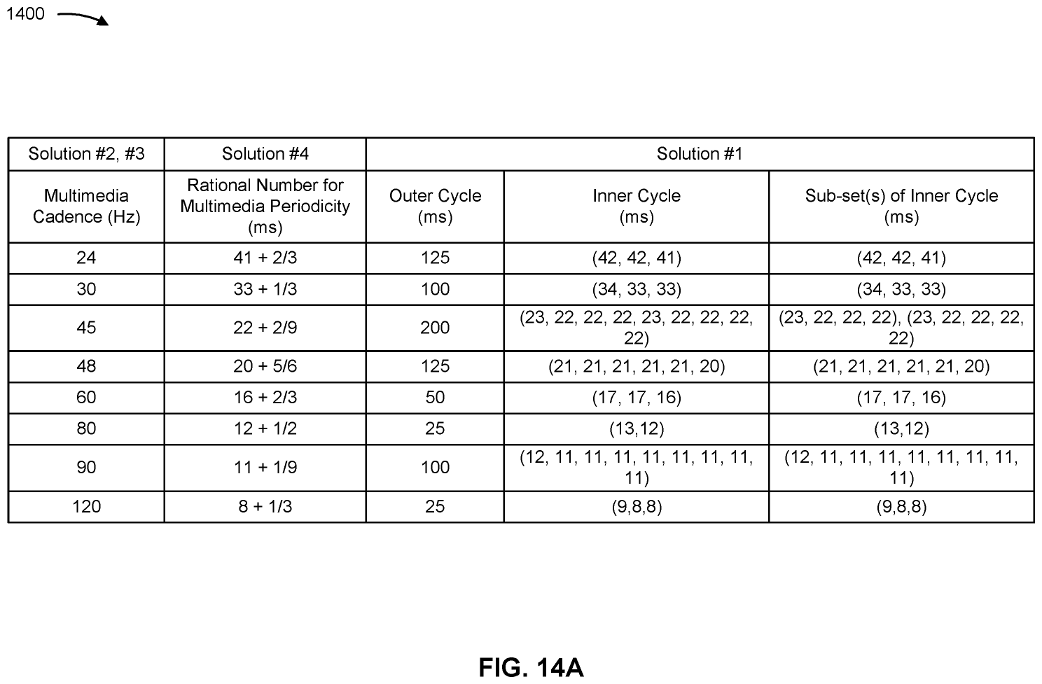

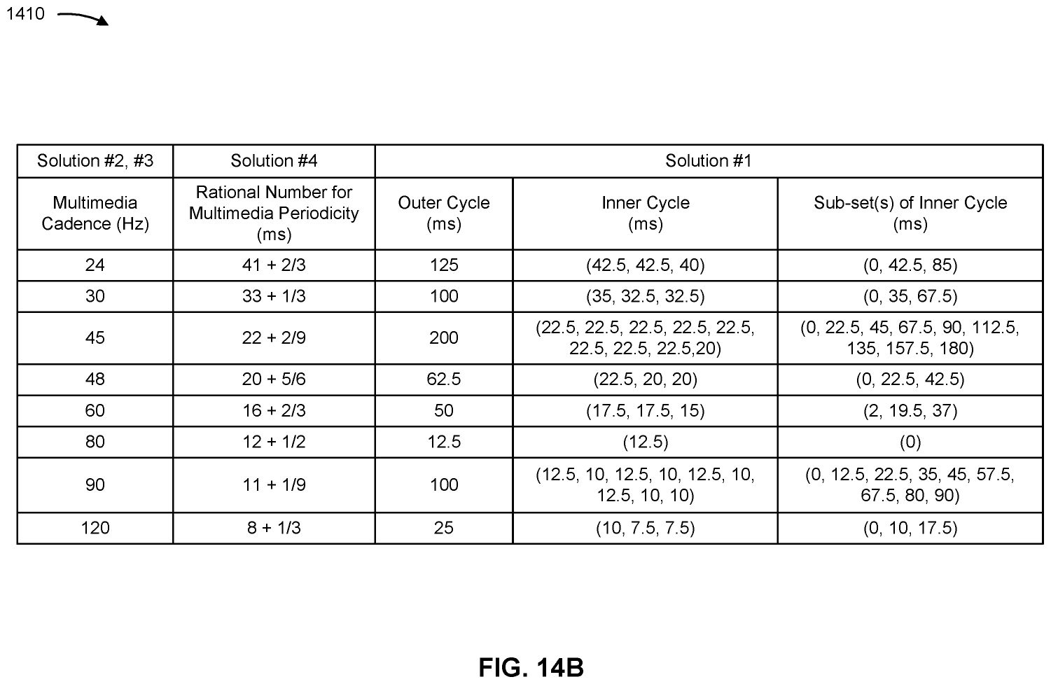

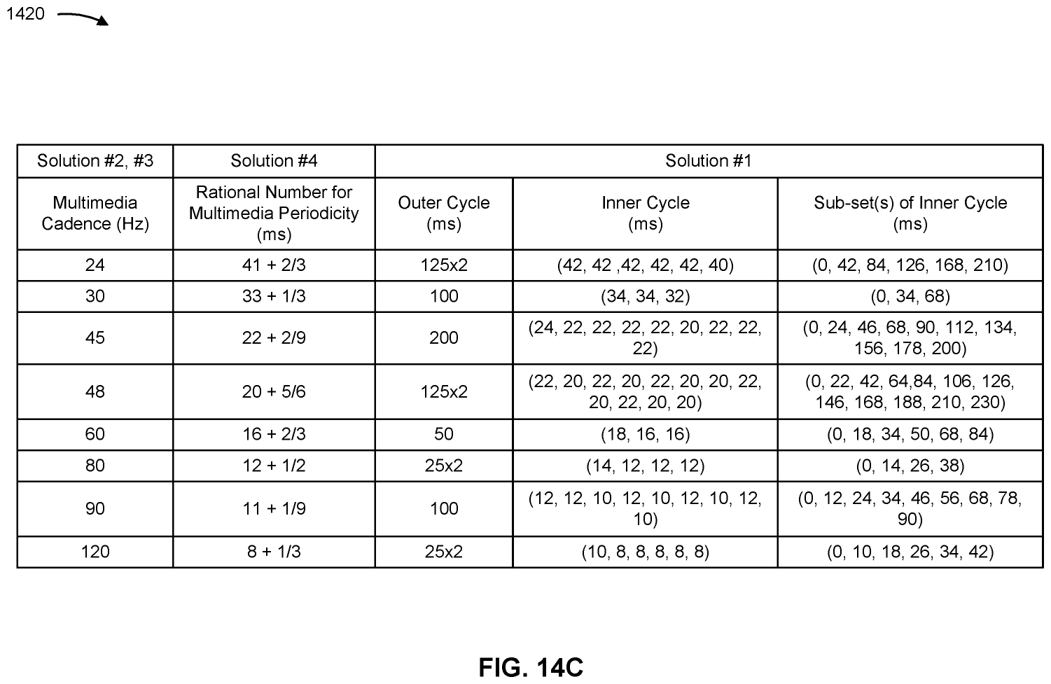

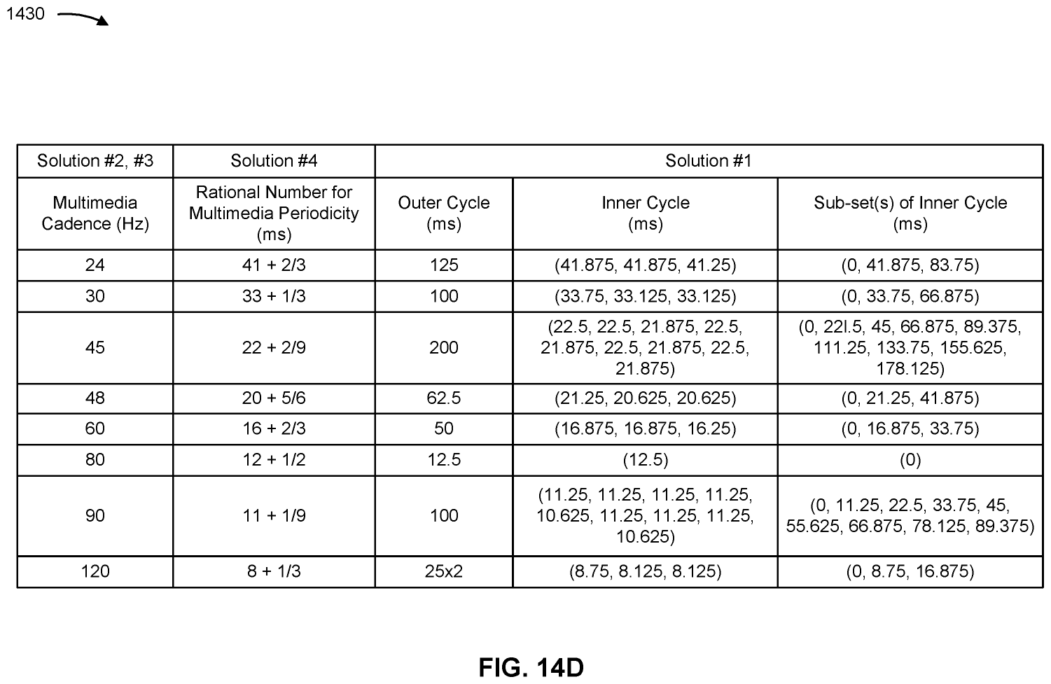

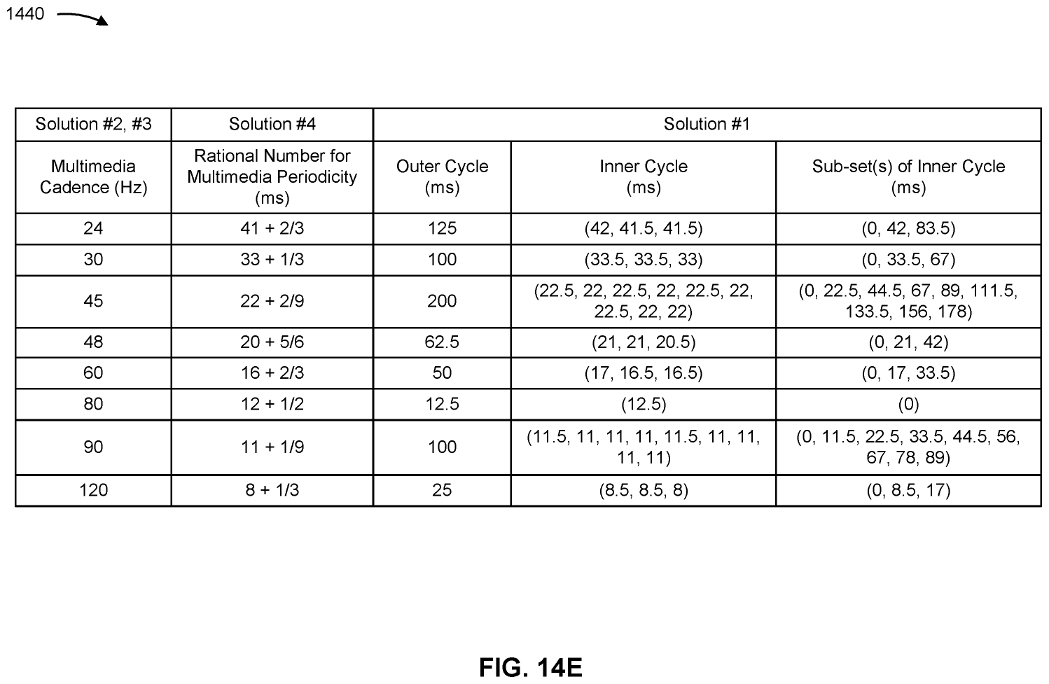

FIGS. 14A-14E are tables illustrating examples 1400-1440 of suboptimal configurations for CG or SPS, in accordance with the present disclosure.

In some aspects, if the network entity does not know the burst arrival of uplink traffic, the network entity may configure the UE with a sub-optimal configuration, which can be generally used regardless of burst arrival time. The UE may request that the network entity shift CG/SPS resources (e.g., via MAC CE or DCI). Any time shift values of CG/SPS may be tolerable with this sub-optimal configuration.

The CG configurations of FIGS. 14A-14E may generally support multimedia traffic without accurate information about a traffic arrival time. The CG configurations may be adopted in a 5G commercial network. In some aspects, to minimize the average latency, the network entity may evenly place the smaller numbers in the middle of inner cycle set, grouped by subset. In some aspects, the bigger inner cycle may be placed in front of the subset to guarantee that multimedia burst traffic arrives before CG/SPS resources.

Example 1400 of FIG. 14A may be for FDD (e.g., not TDD) and 15 kHz SCS. Example 1410 of FIG. 14B may be for TDD-DDDSU (2.5 ms) and 30 kHz SCS. Example 1420 of FIG. 14C may be for TDD-DDSU (2 ms) and 30 kHz SCS. Example 1430 of FIG. 14D may be for TDD-DDDSU (0.625 ms) and 120 kHz SCS. Example 1440 of FIG. 14E may be for TDD-DDDU (0.5 ms) and 120 kHz SCS.

As indicated above, FIGS. 14A-14E are provided as examples. Other examples may differ from what is described with regard to FIGS. 14A-14E.

In some aspects, a network entity may optimize a starting slot for CG Type 1 (e.g., via RRC). The optimal SPS/CG resource may be based at least in part on the start slot position of an outer CG or SPS cycle or a TDD pattern. The network entity may configure a UE with multiple sets of outer CG or SPS cycles. The UE may select a preferred outer CG or SPS cycle from the list. The network entity may configure multiple sets of CG/SPS for multimedia traffic for each slot within an outer cycle or TDD pattern. The UE may transmit a feedback message indicating the set that is preferred for uplink multimedia traffic (e.g. via UAI). The network entity may configure the UE with the selected set of CG/SPS.

In some aspects, a network entity may optimize a starting slot for CG Type 2 (e.g., via RRC and DCI). The network may have one representative set of timedomainoffset that can cover all the possible start slots in a TDD pattern. However, some complex TDD patterns do not allow for a single set of timedomainoffset, and the set can vary according to the start slot position of the TDD pattern. Also, if the network wants to optimize the CG/SPS resource according to the start slot position in TDD pattern, multiple sets of timedomainoffset can be defined for each of the possible slots in the TDD pattern. In some aspects, the network entity may configure a set of timedomainoffset for CG/SPS for each slot in the TDD pattern. The UE may select one of the sets based at least in part on the start slot granted by the DCI with CS-RNTI. For example, with an SPS with TDD Pattern=D₁D₂D₃SU, the network entity may define the optimal sets of multiple timedomainoffset (or the optimal sets of multiple periodicities) separately for each of D₁, D₂, D₃, S slots in the TDD pattern. The network entity may activate the first start slot for SPS resources with DCI with CS-RNTI. Based on the start slot position in the TDD pattern, the UE may utilize the specific set of timedomainoffset from the defined sets.

In some aspects, a network entity may configure multiple CG/SPS configurations that have different CG/SPS resource patterns (e.g., multiple timedomainoffset or periodicity). The HARQ process number field of a DCI with CS-RNTI may indicate an appropriate CG/SPS configuration index (ConfiguredGrantConfigIndex or sps-ConfigIndex), which can indicate an optimal CG/SPS resource pattern (e.g., multiple timedomainoffset or periodicity) according to the start point of CG/SPS. For example, the network entity may have different CG/SPS configurations for each of D₁, D₂, D₃, S slots in the TDD pattern, and select one of the slots with its index based at least in part on the start slot position in the TDD pattern.

In some aspects, UL/DL slots may be aligned for CG/SPS. The formulas of enhanced CG/SPS options can provide the symbol or slot timing that can be aligned with multimedia periodicity. However, the formulas cannot take into account the UL/DL slot of the TDD pattern, and the resource timings may not indicate the UL/DL resource of the TDD pattern. In some aspects, the network entity may use a second formula that realigns the positions of a first CG/SPS formula on specific UL/DL positions of a TDD pattern. For example, the network entity may find the final CG/SPS resources for the next available UL/DL slot in the TDD pattern. The network entity may define the available UL/DL slots for CG/SPS either implicitly (e.g., implicitly align the final CG/SPS slot allocation with the current TDD UL/DL configuration pattern) or explicitly (e.g., define the available UL/DL resource pattern for SPS/CG in an RRC message and align the final CG/SPS slot allocation accordingly).

In some aspects, the network entity may align the final CG/SPS slot allocation with a TDD UL/DL configuration pattern of an RRC message. The network entity may add the second formula or statement that assigns the final CG/SPS slot allocation to the next available UL/DL slot based on the current TDD UL/DL configuration pattern. In some aspects, the network entity may explicitly define the available UL/DL resource pattern for SPS/CG in an RRC message and align the final CG/SPS slot allocation. The network entity may define additional new IEs that align the CG/SPS resource with an UL/DL pattern of the TDD system. In some aspects associated with a CG/SPS TDD resource pattern periodicity, the network entity may define the TDD resource pattern periodicity for CG/SPS transmission. For example, for a TDD pattern of DDDSU, cgTddPattemPeriodicity=2.5 ms, spsTddPattemPeriodicity=2.5 ms, and the sum of dl-UL-TransmissionPeriodicity of pattern1 and pattern 2 may be indicated in TDD-UL-DL-ConfigCommon. dl-UL-TransmissionPeriodicity may be enumerated as {ms0p5, ms0p625, ms1, ms1p25, ms2, ms2p5, ms5, ms10}. In some aspects associated with a CG/SPS TDD resource bitmap, the network entity may define the TDD resource bitmap to indicate which slots are available for CG/SPS transmission. For example, for a TDD pattern of DDDSU, cgBitmap=[00001] and spsBitmap=[11110]. The network entity may add the second formula or statement that assigns the final CG/SPS slot allocation to the next available DL/UL slot based on the proposed message.

In some aspects, the alignment with the TDD pattern and multimedia traffic periodicity may be extended to other resources, such as DRX, channel state information (CSI) reference signals (CSI-RS), CSI interference management (CSI-IM) resources, SRSs, scheduling requests (SRs), CSI reports (e.g., periodic, semi-persistent), buffer status reports (BSRs), physical downlink control channel (PDCCH) monitoring (search space), physical uplink control channel (PUCCH) resources, synchronization signal blocks (SSBs), an SSB based measurement timing configuration (SMTC), random access channel (RACH) procedures, cross-link interference (CLI) RSSI, an RSSI based measurement timing configuration (RMTC), paging messages, and/or system information blocks (SIBs), among other resources.

In some aspects associated with CSI-RS and SRS, a UE may align CSI-RS s or SRSs with a multimedia traffic periodicity and a TDD pattern. For example, for enhanced SRS, a UE may align SRSs with multimedia traffic using a two-level CG/SPS configuration (e.g., inner and outer cycles), A conditional CG/SPS formula using a multimedia traffic cadence, and/or a MAC CE command for shifting the offset. Based at least in part on previous aspects described herein, the UE may set up an SRS periodicity and an offset to be placed on the uplink resources of the TDD pattern. In some aspects, based at least in part on previous aspects described herein, the UE may set up a CSI-RS periodicity and an offset to be placed on the downlink resources of the TDD pattern.

Previous aspects described herein may apply to enhanced DRX. In some aspects, the UE may adjust DRX offset values such that DRX on-duration always starts from downlink slots. The UE does not wake up on the uplink slot, because the UE is expected to start with a DCI in the downlink slot. To make the UE stay longer, the UE may adjust the DRX offsets (inner cycles) to start on the downlink slot. In some aspects, the UE may adjust DRX offset values such that the DRX on-duration can start with specific radio resource timings (e.g., CSI-RS or SRS). In addition, if some of resources (e.g. SRS, CSI-RS) are to be used when the UE wakes up (e.g., update the beamforming or channel status), the DRX offset may be adjusted according to the timing of the relevant resources.

In some aspects associated with CG/SPS and enhanced connected mode DRX (CDRX) the UE may adjust CG/SPS offset values that the CG/SPS resources start with for a DRX on-duration. If a CG/SPS resource is placed in the middle of the inactive state of the UE, the UE has to wake up during the sleep mode and transmit/receive the CG/SPS resources. To conserve power consumption, it would be better to allow the UE to stay in the sleep mode until the DRX on-duration starts by setting the CG/SPS resources before on-duration start or equivalently at the beginning of an on-duration. The UE may skip PDCCH monitoring in the CG occasion at least for UL scheduling.

If the periodicities are different between CG/SPS and DRX cycles (e.g., DL XR Traffic (DRX)=60 Hz, pose (CG/SPS)=90 Hz), the network entity may define the CG/SPS for the pose of 90 Hz aligned with a DL XR Traffic of 60 Hz. In some aspects, the UE may align the resource timing among multiple XR flows, introduce a least common multiple number of XR flows for the common outer cycle (periodicity), and define the multiple offsets of each XR flows within this common outer cycle (periodicity). The network entity may define the specific resource timing that is aligned to both the DL flow (DL XR Traffic) and the UL flow (CG/SPS), even in the case that the periodicities are different. By defining the common outer cycle, the network entity may define the resource timings of two XR flows. In an example with a Flow #1: DL XR Traffic (DRX)=60 Hz (50/3 ms) and a Flow #2: pose (CG/SPS)=90 Hz (100/9 ms), a common outer cycle may be the least common multiple number of the outer cycles of two flows (50 ms, 100 ms)=100 ms. The network entity may define 100 ms to be the periodicity of both DRX and CG/SPS. The offset values of Flow #1 and Flow #2 may be defined within the common outer cycle (periodicity) 100 ms. For Flow #1, there are 6 offset values within the common outer cycle (periodicity) 100 ms. For Flow #2, there are 9 offset values within the common outer cycle (periodicity) 100 ms. Any fine timing adjustments could be possible for these 6 and 9 offset values. The network entity may define resource timings of Flow #1 and Flow #2 within the common periodicity of 100 ms.

In some aspects, to define the resources timing of multiple radio resources with different periodicities, the network entity may define the least common multiple of their outer cycles as the common outer cycle (periodicity) and these include: 1) multiple XR flow periodicity (e.g., DRX, CG/SPS), 2) periodic radio resources (e.g., CSI-RS, SRS: 20 ms or 40 ms), and/or 3) a TDD pattern periodicity (e.g., DDDSU: 2.5 ms, DDDU: 2 ms). DRX for multiple XR flows may be supported by various aspects described herein.

Various aspects described herein align the CG/SPS transmission communication times with the multimedia traffic, improving downlink/uplink scheduling, power consumption, and system performance.

FIG. 15 is a diagram illustrating an example process 1500 performed, for example, by a UE, in accordance with the present disclosure. Example process 1500 is an example where the UE (e.g., UE 120, UE 920) performs operations associated with configuring communications for multimedia traffic and TDD resources.

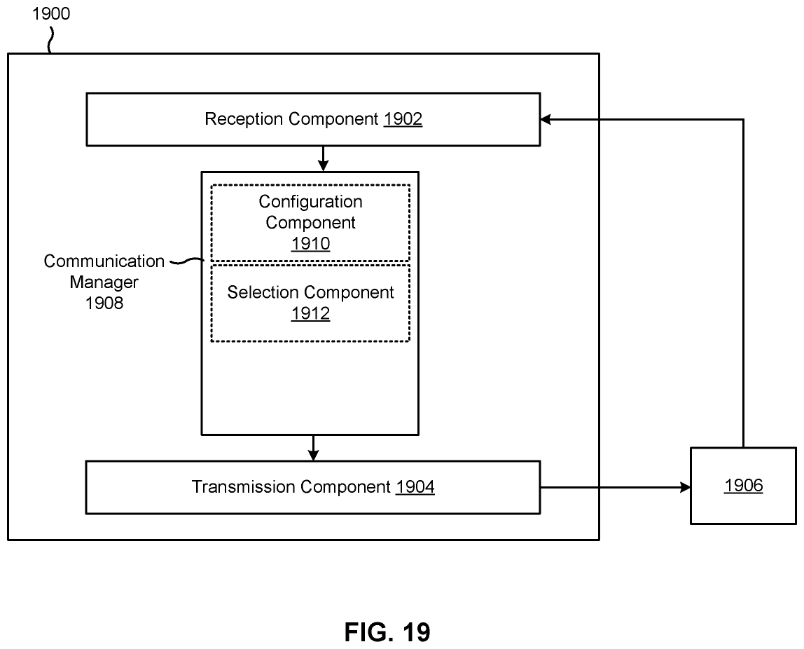

As shown in FIG. 15, in some aspects, process 1500 may include obtaining a configuration for an outer CG or SPS cycle with communication times within the outer CG or SPS cycle that are multiples of a TDD periodicity and that are based at least in part on a multimedia traffic periodicity (block 1510). For example, the UE (e.g., using communication manager 1908 and/or configuration component 1910 depicted in FIG. 19) may obtain a configuration for an outer CG or SPS cycle with communication times within the outer CG or SPS cycle that are multiples of a TDD periodicity and that are based at least in part on a multimedia traffic periodicity, as described above.

As further shown in FIG. 15, in some aspects, process 1500 may include transmitting or receiving communications at the communication times (block 1520). For example, the UE (e.g., using communication manager 1908, reception component 1902, and/or transmission component 1904 depicted in FIG. 19) may transmit or receive communications at the communication times, as described above.

Process 1500 may include additional aspects, such as any single aspect or any combination of aspects described below and/or in connection with one or more other processes described elsewhere herein.

In a first aspect, the communication times are based at least in part on a TDD pattern of resources granted by CG type 1 or CG type 2.

In a second aspect, alone or in combination with the first aspect, obtaining the configuration includes receiving the configuration or obtaining the configuration from stored configuration information.

In a third aspect, alone or in combination with one or more of the first and second aspects, the communication times are based at least in part on inner CG or SPS cycles configured for the outer CG or SPS cycle, and wherein a sum of the inner CG or SPS cycles is equal to the outer CG or SPS cycle.

In a fourth aspect, alone or in combination with one or more of the first through third aspects, the communication times are based at least in part on time domain offset values configured for the outer CG or SPS cycle.

In a fifth aspect, alone or in combination with one or more of the first through fourth aspects, the time domain offset values align with an uplink or downlink resource that is nearest to a multimedia traffic burst.

In a sixth aspect, alone or in combination with one or more of the first through fifth aspects, the time domain offset values align with an uplink or downlink resource that is after and nearest to a multimedia traffic burst.

In a seventh aspect, alone or in combination with one or more of the first through sixth aspects, the outer CG or SPS cycle is for CG type 2, and wherein the method includes receiving an information element that indicates the time domain offset values for the outer CG or SPS cycle.

In an eighth aspect, alone or in combination with one or more of the first through seventh aspects, the outer CG or SPS cycle is for CG type 1.

In a ninth aspect, alone or in combination with one or more of the first through eighth aspects, the outer CG or SPS cycle is for CG type 2, and wherein the method includes receiving DCI that indicates a start time of the outer CG or SPS cycle.

In a tenth aspect, alone or in combination with one or more of the first through ninth aspects, the DCI indicates different values to use for determining time domain offset values for the communication times within the outer CG or SPS cycle, indicates a set of periodicities for multimedia traffic bursts, or indicates a set of associated CG or SPS configurations.

In an eleventh aspect, alone or in combination with one or more of the first through tenth aspects, process 1500 includes extending a length of the outer CG or SPS cycle to align with the TDD periodicity.

In a twelfth aspect, alone or in combination with one or more of the first through eleventh aspects, extending the length of the outer CG or SPS cycle includes extending the outer CG or SPS cycle to be a common multiple of the outer CG or SPS cycle and the TDD periodicity.

In a thirteenth aspect, alone or in combination with one or more of the first through twelfth aspects, process 1500 includes receiving an indication of a set of multiple outer CG or SPS cycles, each outer CG or SPS cycle having a pattern of communication times, selecting the outer CG or SPS cycle from among the set of multiple outer CG or SPS cycles based at least in part on one or more of an outer cycle starting slot or a TDD pattern, and transmitting an indication of the selected outer CG or SPS cycle.

In a fourteenth aspect, alone or in combination with one or more of the first through thirteenth aspects, process 1500 includes receiving an indication of a set of time domain value offsets of the outer CG or SPS cycle for each slot in a TDD pattern, selecting, for the outer CG or SPS cycle, the set of time domain offset values for a slot in the TDD pattern that corresponds to a start slot or a configuration index indicated by DCI, and transmitting an indication of the selected set of time domain offset values.

In a fifteenth aspect, alone or in combination with one or more of the first through fourteenth aspects, process 1500 includes aligning the communication times with slots that are allocated according to a current TDD pattern.

In a sixteenth aspect, alone or in combination with one or more of the first through fifteenth aspects, process 1500 includes receiving an indication of a TDD pattern, and aligning the communication times with slots that are allocated according to the TDD pattern.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network entity, in accordance with the present disclosure. Example process 1600 is an example where the network entity (e.g., base station 110, network entity 910) performs operations associated with configuring communications for multimedia traffic and TDD resources.

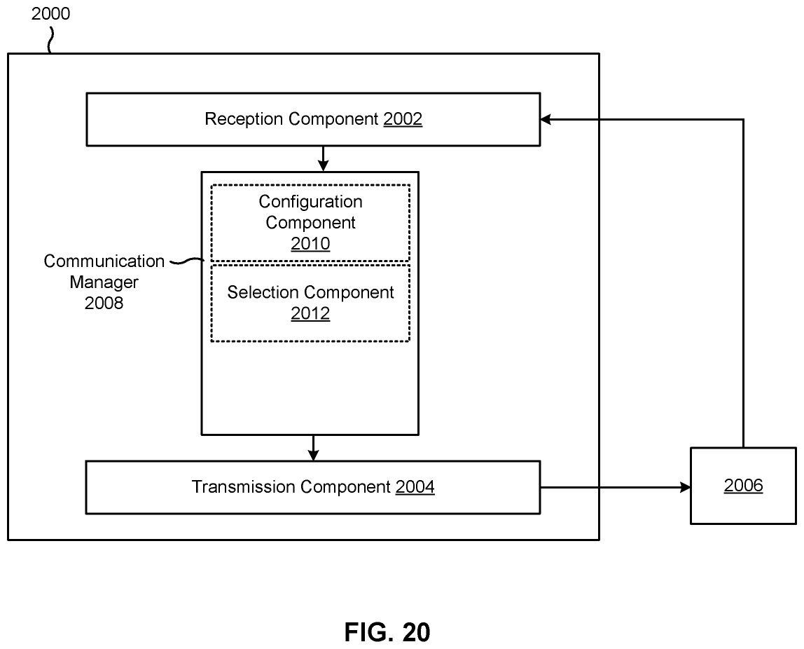

As shown in FIG. 16, in some aspects, process 1600 may include transmitting a configuration for an outer CG or SPS cycle with communication times within the outer CG or SPS cycle that are multiples of a TDD periodicity and that are based at least in part on a multimedia traffic periodicity (block 1610). For example, the network entity (e.g., using communication manager 2008 and/or transmission component 2004 depicted in FIG. 20) may transmit a configuration for an outer CG or SPS cycle with communication times within the outer CG or SPS cycle that are multiples of a TDD periodicity and that are based at least in part on a multimedia traffic periodicity, as described above.

As further shown in FIG. 16, in some aspects, process 1600 may include transmitting or receiving communications at the communication times (block 1620). For example, the network entity (e.g., using communication manager 2008 and/or transmission component 2004 depicted in FIG. 20) may transmit or receive communications at the communication times, as described above.

Process 1600 may include additional aspects, such as any single aspect or any combination of aspects described below and/or in connection with one or more other processes described elsewhere herein.

In a first aspect, the communication times are based at least in part on a TDD pattern of resources granted by CG type 1 or CG type 2.

In a second aspect, alone or in combination with the first aspect, the communication times are based at least in part on inner CG or SPS cycles configured for the outer CG or SPS cycle, and wherein a sum of the inner CG or SPS cycles is equal to the outer CG or SPS cycle.

In a third aspect, alone or in combination with one or more of the first and second aspects, the communication times are based at least in part on time domain offset values configured for the outer CG or SPS cycle.

In a fourth aspect, alone or in combination with one or more of the first through third aspects, the time domain offset values align with an uplink or downlink resource that is nearest to a multimedia traffic burst.

In a fifth aspect, alone or in combination with one or more of the first through fourth aspects, the time domain offset values align with an uplink or downlink resource that is after and nearest to a multimedia traffic burst.

In a sixth aspect, alone or in combination with one or more of the first through fifth aspects, the outer CG or SPS cycle is for CG type 2, and process 1600 includes transmitting an IE that indicates the time domain offset values for the outer CG or SPS cycle.

In a seventh aspect, alone or in combination with one or more of the first through sixth aspects, the outer CG or SPS cycles is for CG type 1.

In an eighth aspect, alone or in combination with one or more of the first through seventh aspects, the outer CG or SPS cycle is for CG type 2, and wherein the method includes transmitting DCI that indicates a start time of the outer CG or SPS cycle.

In a ninth aspect, alone or in combination with one or more of the first through eighth aspects, the DCI indicates different values to use for determining time domain offset values for the communication times within the outer CG or SPS cycle, indicates a set of periodicities for multimedia traffic bursts, or indicates a set of associated CG or SPS configurations.

In a tenth aspect, alone or in combination with one or more of the first through ninth aspects, process 1600 includes extending a length of the outer CG or SPS cycle to align with a TDD periodicity.

In an eleventh aspect, alone or in combination with one or more of the first through tenth aspects, extending the length of the outer CG or SPS cycle includes extending the outer CG or SPS cycle to be a common multiple of the outer CG or SPS cycle and the TDD periodicity.

In a twelfth aspect, alone or in combination with one or more of the first through eleventh aspects, process 1600 includes selecting the communication times based at least in part on having information about an arrival time of an initial multimedia traffic burst or based at least in part on a request associated with a relative shift.

In a thirteenth aspect, alone or in combination with one or more of the first through twelfth aspects, process 1600 includes selecting a preconfigured communication time pattern in the outer CG or SPS cycle as the configuration based at least in part on not having information about an arrival time of an initial multimedia traffic burst.

In a fourteenth aspect, alone or in combination with one or more of the first through thirteenth aspects, process 1600 includes transmitting an indication of a set of multiple outer CG or SPS cycles, each outer CG or SPS cycle having a pattern of communication times, receiving an indication of a selected outer CG or SPS cycle, and generating the configuration based at least in part on the selected outer CG or SPS cycle.

In a fifteenth aspect, alone or in combination with one or more of the first through fourteenth aspects, process 1600 includes transmitting an indication of a set of time domain value offsets of the outer CG or SPS cycle for each slot in a TDD pattern, receiving an indication of a selected set of time domain offset values, and generating the configuration based at least in part on the selected set of time domain offset values.

In a sixteenth aspect, alone or in combination with one or more of the first through fifteenth aspects, process 1600 includes transmitting an indication of a TDD pattern for aligning communication times with slots of the TDD pattern.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a UE, in accordance with the present disclosure. Example process 1700 is an example where the UE (e.g., UE 120, UE 920) performs operations associated with configuring communications for multimedia traffic and TDD resources.

As shown in FIG. 17, in some aspects, process 1700 may include receiving a configuration for a periodicity of communication times that are evenly divided by or are multiples of a TDD periodicity and that are based at least in part on a multimedia traffic periodicity (block 1710). For example, the UE (e.g., using communication manager 1908 and/or reception component 1902 depicted in FIG. 19) may receive a configuration for a periodicity of communication times that are evenly divided by or are multiples of a TDD periodicity and that are based at least in part on a multimedia traffic periodicity, as described above.

As further shown in FIG. 17, in some aspects, process 1700 may include transmitting or receiving communications at the communication times (block 1720). For example, the UE (e.g., using communication manager 1908 and/or transmission component 1904 depicted in FIG. 19) may transmit or receive communications at the communication times, as described above.

Process 1700 may include additional aspects, such as any single aspect or any combination of aspects described below and/or in connection with one or more other processes described elsewhere herein.

In a first aspect, the communication times are based at least in part on a TDD pattern of granted resources.

In a second aspect, alone or in combination with the first aspect, the communication times are of a DRX cycle.

In a third aspect, alone or in combination with one or more of the first and second aspects, process 1700 includes adjusting DRX offsets values such that DRX on-durations align with downlink slots of a TDD pattern.

In a fourth aspect, alone or in combination with one or more of the first through third aspects, process 1700 includes adjusting DRX offsets values such that DRX on-durations align with specific radio resource timings.

In a fifth aspect, alone or in combination with one or more of the first through fourth aspects, process 1700 includes adjusting DRX offsets values such that DRX on-durations align with outer configured grant or semi-persistent scheduling cycles.

In a sixth aspect, alone or in combination with one or more of the first through fifth aspects, the communications are CSI-RSs or CSI-IM resources.

In a seventh aspect, alone or in combination with one or more of the first through sixth aspects, process 1700 includes aligning a periodicity and offset of the CSI-RSs with downlink slots of a TDD pattern.

In an eighth aspect, alone or in combination with one or more of the first through seventh aspects, the communications are SRSs.

In a ninth aspect, alone or in combination with one or more of the first through eighth aspects, process 1700 includes aligning the SRSs with uplink slots of a TDD pattern.

In a tenth aspect, alone or in combination with one or more of the first through ninth aspects, the communications are scheduling requests.

In an eleventh aspect, alone or in combination with one or more of the first through tenth aspects, the communications are channel state information reports or buffer status reports.

In a twelfth aspect, alone or in combination with one or more of the first through eleventh aspects, the communications are transmitted in physical uplink channel resources or received in physical downlink channel resources.

In a thirteenth aspect, alone or in combination with one or more of the first through twelfth aspects, the communications are SSBs.

In a fourteenth aspect, alone or in combination with one or more of the first through thirteenth aspects, the communications are random access channel messages.

In a fifteenth aspect, alone or in combination with one or more of the first through fourteenth aspects, the communications are CLI measurement resources.

In a sixteenth aspect, alone or in combination with one or more of the first through fifteenth aspects, the communications are signal strength or signal quality measurement resources.

In a seventeenth aspect, alone or in combination with one or more of the first through sixteenth aspects, the communications are paging messages.

In an eighteenth aspect, alone or in combination with one or more of the first through seventeenth aspects, the communications are system information blocks.

In a nineteenth aspect, alone or in combination with one or more of the first through eighteenth aspects, process 1700 includes aligning a resource timing among multiple multimedia traffic flows based at least in part on a common multiple quantity of multimedia traffic flows for a common outer cycle.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a network entity, in accordance with the present disclosure. Example process 1800 is an example where the network entity (e.g., base station 110, network entity 910) performs operations associated with configuring communications for multimedia traffic and TDD resources.

As shown in FIG. 18, in some aspects, process 1800 may include transmitting a configuration for a periodicity of communication times that are evenly divided by or are multiples of a TDD periodicity and that are based at least in part on a multimedia traffic periodicity (block 1810). For example, the network entity (e.g., using communication manager 2008 and/or transmission component 2004 depicted in FIG. 20) may transmit a configuration for a periodicity of communication times that are evenly divided by or are multiples of a TDD periodicity and that are based at least in part on a multimedia traffic periodicity, as described above.

As further shown in FIG. 18, in some aspects, process 1800 may include transmitting or receiving communications at the communication times (block 1820). For example, the network entity (e.g., using communication manager 2008 and/or transmission component 2004 depicted in FIG. 20) may transmit or receive communications at the communication times, as described above.

Process 1800 may include additional aspects, such as any single aspect or any combination of aspects described below and/or in connection with one or more other processes described elsewhere herein.

In a first aspect, the communication times are based at least in part on a TDD pattern of granted resources.

In a second aspect, alone or in combination with the first aspect, the communication times are of a DRX cycle.

In a third aspect, alone or in combination with one or more of the first and second aspects, process 1800 includes adjusting DRX offsets values such that DRX on-durations align with downlink slots of a TDD pattern.

In a fourth aspect, alone or in combination with one or more of the first through third aspects, process 1800 includes adjusting DRX offsets values such that DRX on-durations align with specific radio resource timings.

In a fifth aspect, alone or in combination with one or more of the first through fourth aspects, process 1800 includes adjusting DRX offsets values such that DRX on-durations align with outer configured grant or semi-persistent scheduling cycles.

In a sixth aspect, alone or in combination with one or more of the first through fifth aspects, the communications are CSI-RSs or CSI-IM resources.

In a seventh aspect, alone or in combination with one or more of the first through sixth aspects, process 1800 includes aligning a periodicity and offset of the CSI-RSs with downlink slots of a TDD pattern.

In an eighth aspect, alone or in combination with one or more of the first through seventh aspects, the communications are SRSs.

In a ninth aspect, alone or in combination with one or more of the first through eighth aspects, process 1800 includes aligning the SRSs with uplink slots of a TDD pattern.

In a tenth aspect, alone or in combination with one or more of the first through ninth aspects, the communications are scheduling requests.

In an eleventh aspect, alone or in combination with one or more of the first through tenth aspects, the communications are CSI reports or buffer status reports.

In a twelfth aspect, alone or in combination with one or more of the first through eleventh aspects, the communications are transmitted in physical uplink channel resources or received in physical downlink channel resources.

In a thirteenth aspect, alone or in combination with one or more of the first through twelfth aspects, the communications are SSBs.

In a fourteenth aspect, alone or in combination with one or more of the first through thirteenth aspects, the communications are random access channel messages.

In a fifteenth aspect, alone or in combination with one or more of the first through fourteenth aspects, the communications are CLI measurement resources.

In a sixteenth aspect, alone or in combination with one or more of the first through fifteenth aspects, the communications are signal strength or signal quality measurement resources.

In a seventeenth aspect, alone or in combination with one or more of the first through sixteenth aspects, the communications are paging messages.

In an eighteenth aspect, alone or in combination with one or more of the first through seventeenth aspects, the communications are SIB s.

In a nineteenth aspect, alone or in combination with one or more of the first through eighteenth aspects, process 1800 includes aligning a resource timing among multiple multimedia traffic flows based at least in part on a common multiple quantity of multimedia traffic flows for a common outer cycle.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE (e.g., UE 20, UE 920), or a UE may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a base station, or another wireless communication device) using the reception component 1902 and the transmission component 1904. As further shown, the apparatus 1900 may include the communication manager 1908. The communication manager 1908 may control and/or otherwise manage one or more operations of the reception component 1902 and/or the transmission component 1904. In some aspects, the communication manager 1908 may include one or more antennas, a modem, a controller/processor, a memory, or a combination thereof, of the UE described in connection with FIG. 2. The communication manager 1908 may be, or be similar to, the communication manager 140 depicted in FIGS. 1 and 2. For example, in some aspects, the communication manager 1908 may be configured to perform one or more of the functions described as being performed by the communication manager 140. In some aspects, the communication manager 1908 may include the reception component 1902 and/or the transmission component 1904. The communication manager 1908 may include a configuration component 1910 and/or a selection component 1912, among other examples.

In some aspects, the apparatus 1900 may be configured to perform one or more operations described herein in connection with FIGS. 1-14E. Additionally, or alternatively, the apparatus 1900 may be configured to perform one or more processes described herein, such as process 1500 of FIG. 15, process 17 of FIG. 17, or a combination thereof. In some aspects, the apparatus 1900 and/or one or more components shown in FIG. 19 may include one or more components of the UE described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the UE described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the UE described in connection with FIG. 2. In some aspects, the transmission component 1904 may be co-located with the reception component 1902 in a transceiver.

In some aspects, the configuration component 1910 may obtain a configuration for an outer CG or SPS cycle with communication times within the outer CG or SPS cycle that are multiples of a TDD periodicity and that are based at least in part on a multimedia traffic periodicity. The transmission component 1904 may transmit or receive communications at the communication times.

The configuration component 1910 may extend a length of the outer CG or SPS cycle to align with the TDD periodicity. The reception component 1902 may receive an indication of a set of multiple outer CG or SPS cycles, each outer CG or SPS cycle having a pattern of communication times.

The selection component 1912 may select the outer CG or SPS cycle from among the set of multiple outer CG or SPS cycles based at least in part on one or more of an outer cycle starting slot or a TDD pattern. The transmission component 1904 may transmit an indication of the selected outer CG or SPS cycle. The reception component 1902 may receive an indication of a set of time domain value offsets of the outer CG or SPS cycle for each slot in a TDD pattern.

The selection component 1912 may select, for the outer CG or SPS cycle, the set of time domain offset values for a slot in the TDD pattern that corresponds to a start slot or a configuration index indicated by DCI. The transmission component 1904 may transmit an indication of the selected set of time domain offset values. The selection component 1912 may align the communication times with slots that are allocated according to a current TDD pattern.

The reception component 1902 may receive an indication of a TDD pattern. The selection component 1912 may align the communication times with slots that are allocated according to the TDD pattern.

In some aspects, the reception component 1902 may receive a configuration for a periodicity of communication times that are evenly divided by or are multiples of a TDD periodicity and that are based at least in part on a multimedia traffic periodicity. The transmission component 1904 may transmit or receive communications at the communication times.

The selection component 1912 may adjust DRX offsets values such that DRX on-durations align with downlink slots of a TDD pattern. The selection component 1912 may adjust DRX offsets values such that DRX on-durations align with specific radio resource timings. The selection component 1912 may adjust DRX offsets values such that DRX on-durations align with outer configured grant or semi-persistent scheduling cycles. The selection component 1912 may align a periodicity and offset of the CSI-RS s with downlink slots of a TDD pattern. The selection component 1912 may align the SRSs with uplink slots of a TDD pattern. The selection component 1912 may align a resource timing among multiple multimedia traffic flows based at least in part on a common multiple quantity of multimedia traffic flows for a common outer cycle.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network entity (e.g., base station 110, network entity 910), or a network entity may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE, a base station, or another wireless communication device) using the reception component 2002 and the transmission component 2004. As further shown, the apparatus 2000 may include the communication manager 2008. The communication manager 2008 may control and/or otherwise manage one or more operations of the reception component 2002 and/or the transmission component 2004. In some aspects, the communication manager 2008 may include one or more antennas, a modem, a controller/processor, a memory, or a combination thereof, of the network entity described in connection with FIG. 2. The communication manager 2008 may be, or be similar to, the communication manager 150 depicted in FIGS. 1 and 2. For example, in some aspects, the communication manager 2008 may be configured to perform one or more of the functions described as being performed by the communication manager 150. In some aspects, the communication manager 2008 may include the reception component 2002 and/or the transmission component 2004. The communication manager 2008 may include a configuration component 2010 and/or a selection component 2012, among other examples.

In some aspects, the apparatus 2000 may be configured to perform one or more operations described herein in connection with FIGS. 1-14E. Additionally, or alternatively, the apparatus 2000 may be configured to perform one or more processes described herein, such as process 1600 of FIG. 16, process 1800 of FIG. 18, or a combination thereof. In some aspects, the apparatus 2000 and/or one or more components shown in FIG. 20 may include one or more components of the network entity described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the network entity described in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a modulator, a transmit MIMO processor, a transmit processor, a controller/processor, a memory, or a combination thereof, of the network entity described in connection with FIG. 2. In some aspects, the transmission component 2004 may be co-located with the reception component 2002 in a transceiver.

In some aspects, the transmission component 2004 may transmit a configuration for an outer CG or SPS cycle with communication times within the outer CG or SPS cycle that are multiples of a TDD periodicity and that are based at least in part on a multimedia traffic periodicity. The transmission component 2004 may transmit or receive communications at the communication times.

The configuration component 2010 may extend a length of the outer CG or SPS cycle to align with a TDD periodicity. The selection component 2012 may select the communication times based at least in part on having information about an arrival time of an initial multimedia traffic burst or based at least in part on a request associated with a relative shift. The selection component 2012 may select a preconfigured communication time pattern in the outer CG or SPS cycle as the configuration based at least in part on not having information about an arrival time of an initial multimedia traffic burst.

The transmission component 2004 may transmit an indication of a set of multiple outer CG or SPS cycles, each outer CG or SPS cycle having a pattern of communication times. The reception component 2002 may receive an indication of a selected outer CG or SPS cycle. The configuration component 2010 may generate the configuration based at least in part on the selected outer CG or SPS cycle.

The transmission component 2004 may transmit an indication of a set of time domain value offsets of the outer CG or SPS cycle for each slot in a TDD pattern. The reception component 2002 may receive an indication of a selected set of time domain offset values.

The configuration component 2010 may generate the configuration based at least in part on the selected set of time domain offset values. The transmission component 2004 may transmit an indication of a TDD pattern for aligning communication times with slots of the TDD pattern.

In some aspects, the transmission component 2004 may transmit a configuration for a periodicity of communication times that are evenly divided by or are multiples of a TDD periodicity and that are based at least in part on a multimedia traffic periodicity. The transmission component 2004 may transmit or receive communications at the communication times.

The configuration component 2010 may adjust DRX offsets values such that DRX on-durations align with downlink slots of a TDD pattern. The configuration component 2010 may adjust DRX offsets values such that DRX on-durations align with specific radio resource timings. The configuration component 2010 may adjust DRX offsets values such that DRX on-durations align with outer configured grant or semi-persistent scheduling cycles. The configuration component 2010 may align a periodicity and offset of the CSI-RS s with downlink slots of a TDD pattern. The configuration component 2010 may align the SRSs with uplink slots of a TDD pattern. The configuration component 2010 may align a resource timing among multiple multimedia traffic flows based at least in part on a common multiple quantity of multimedia traffic flows for a common outer cycle.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:

Aspect 1: A method of wireless communication performed by a UE, comprising: obtaining a configuration for an outer configured grant (CG) or semi-persistent scheduling (SPS) cycle with communication times within the outer CG or SPS cycle that are multiples of a time division duplex (TDD) periodicity and that are based at least in part on a multimedia traffic periodicity; and transmitting or receiving communications at the communication times.

Aspect 2: The method of Aspect 1, wherein the communication times are based at least in part on a TDD pattern of resources granted by CG type 1 or CG type 2.

Aspect 3: The method of any of Aspects 1-2, wherein obtaining the configuration includes receiving the configuration or obtaining the configuration from stored configuration information.

Aspect 4: The method of any of Aspects 1-3, wherein the communication times are based at least in part on inner CG or SPS cycles configured for the outer CG or SPS cycle, and wherein a sum of the inner CG or SPS cycles is equal to the outer CG or SPS cycle.

Aspect 5: The method of any of Aspects 1-4, wherein the communication times are based at least in part on time domain offset values configured for the outer CG or SPS cycle.

Aspect 6: The method of Aspect 5, wherein the time domain offset values align with an uplink or downlink resource that is nearest to a multimedia traffic burst.

Aspect 7: The method of Aspect 5, wherein the time domain offset values align with an uplink or downlink resource that is after and nearest to a multimedia traffic burst.

Aspect 8: The method of Aspect 5, wherein the outer CG or SPS cycle is for CG type 2, and wherein the method includes receiving an information element that indicates the time domain offset values for the outer CG or SPS cycle.

Aspect 9: The method of any of Aspects 1-8, wherein the outer CG or SPS cycle is for CG type 1.

Aspect 10: The method of any of Aspects 1-9, wherein the outer CG or SPS cycle is for CG type 2, and wherein the method includes receiving downlink control information (DCI) that indicates a start time of the outer CG or SPS cycle.

Aspect 11: The method of Aspect 10, wherein the DCI indicates different values to use for determining time domain offset values for the communication times within the outer CG or SPS cycle, indicates a set of periodicities for multimedia traffic bursts, or indicates a set of associated CG or SPS configurations.

Aspect 12: The method of any of Aspects 1-11, further comprising extending a length of the outer CG or SPS cycle to align with the TDD periodicity.

Aspect 13: The method of Aspect 12, wherein extending the length of the outer CG or SPS cycle includes extending the outer CG or SPS cycle to be a common multiple of the outer CG or SPS cycle and the TDD periodicity.

Aspect 14: The method of any of Aspects 1-13, further comprising: receiving an indication of a set of multiple outer CG or SPS cycles, each outer CG or SPS cycle having a pattern of communication times; selecting the outer CG or SPS cycle from among the set of multiple outer CG or SPS cycles based at least in part on one or more of an outer cycle starting slot or a TDD pattern; and transmitting an indication of the selected outer CG or SPS cycle.

Aspect 15: The method of any of Aspects 1-14, further comprising: receiving an indication of a set of time domain value offsets of the outer CG or SPS cycle for each slot in a TDD pattern; selecting, for the outer CG or SPS cycle, the set of time domain offset values for a slot in the TDD pattern that corresponds to a start slot or a configuration index indicated by downlink control information; and transmitting an indication of the selected set of time domain offset values.

Aspect 16: The method of any of Aspects 1-15, further comprising aligning the communication times with slots that are allocated according to a current TDD pattern.

Aspect 17: The method of any of Aspects 1-16, further comprising: receiving an indication of a TDD pattern; and aligning the communication times with slots that are allocated according to the TDD pattern.

Aspect 18: A method of wireless communication performed by a network entity, comprising: transmitting a configuration for an outer configured grant (CG) or semi-persistent scheduling (SPS) cycle with communication times within the outer CG or SPS cycle that are multiples of a time division duplex (TDD) periodicity and that are based at least in part on a multimedia traffic periodicity; and transmitting or receiving communications at the communication times.

Aspect 19: The method of Aspect 18, wherein the communication times are based at least in part on a TDD pattern of resources granted by CG type 1 or CG type 2.

Aspect 20: The method of any of Aspects 18-19, wherein the communication times are based at least in part on inner CG or SPS cycles configured for the outer CG or SPS cycle, and wherein a sum of the inner CG or SPS cycles is equal to the outer CG or SPS cycle.

Aspect 21: The method of any of Aspects 18-20, wherein the communication times are based at least in part on time domain offset values configured for the outer CG or SPS cycle.

Aspect 22: The method of Aspect 21, wherein the time domain offset values align with an uplink or downlink resource that is nearest to a multimedia traffic burst.

Aspect 23: The method of Aspect 21, wherein the time domain offset values align with an uplink or downlink resource that is after and nearest to a multimedia traffic burst.

Aspect 24: The method of Aspect 21, wherein the outer CG or SPS cycle is for CG type 2, and wherein the method includes transmitting an information element that indicates the time domain offset values for the outer CG or SPS cycle.

Aspect 25: The method of any of Aspects 18-24, wherein the outer CG or SPS cycles is for CG type 1.

Aspect 26: The method of any of Aspects 18-25, wherein the outer CG or SPS cycle is for CG type 2, and wherein the method includes transmitting downlink control information (DCI) that indicates a start time of the outer CG or SPS cycle.

Aspect 27: The method of Aspect 26, wherein the DCI indicates different values to use for determining time domain offset values for the communication times within the outer CG or SPS cycle, indicates a set of periodicities for multimedia traffic bursts, or indicates a set of associated CG or SPS configurations.

Aspect 28: The method of any of Aspects 18-27, further comprising extending a length of the outer CG or SPS cycle to align with a TDD periodicity.

Aspect 29: The method of Aspect 28, wherein extending the length of the outer CG or SPS cycle includes extending the outer CG or SPS cycle to be a common multiple of the outer CG or SPS cycle and the TDD periodicity.

Aspect 30: The method of any of Aspects 18-29, further comprising selecting the communication times based at least in part on having information about an arrival time of an initial multimedia traffic burst or based at least in part on a request associated with a relative shift.

Aspect 31: The method of any of Aspects 18-30, further comprising selecting a preconfigured communication time pattern in the outer CG or SPS cycle as the configuration based at least in part on not having information about an arrival time of an initial multimedia traffic burst.

Aspect 32: The method of any of Aspects 18-31, further comprising: transmitting an indication of a set of multiple outer CG or SPS cycles, each outer CG or SPS cycle having a pattern of communication times; receiving an indication of a selected outer CG or SPS cycle; and generating the configuration based at least in part on the selected outer CG or SPS cycle.

Aspect 33: The method of any of Aspects 18-32, further comprising: transmitting an indication of a set of time domain value offsets of the outer CG or SPS cycle for each slot in a TDD pattern; receiving an indication of a selected set of time domain offset values; and generating the configuration based at least in part on the selected set of time domain offset values.

Aspect 34: The method of any of Aspects 18-33, further comprising transmitting an indication of a TDD pattern for aligning communication times with slots of the TDD pattern.

Aspect 35: A method of wireless communication performed by a user equipment (UE), comprising: receiving a configuration for a periodicity of communication times that are evenly divided by or are multiples of a time division duplex (TDD) periodicity and that are based at least in part on a multimedia traffic periodicity; and transmitting or receiving communications at the communication times.

Aspect 36: The method of Aspect 35, wherein the communication times are based at least in part on a TDD pattern of granted resources.

Aspect 37: The method of any of Aspects 35-36, wherein the communication times are of a discontinuous reception (DRX) cycle.

Aspect 38: The method of Aspect 37, further comprising adjusting DRX offsets values such that DRX on-durations align with downlink slots of a TDD pattern.

Aspect 39: The method of Aspect 37, further comprising adjusting DRX offsets values such that DRX on-durations align with specific radio resource timings.

Aspect 40: The method of Aspect 37, further comprising adjusting DRX offsets values such that DRX on-durations align with outer configured grant or semi-persistent scheduling cycles.

Aspect 41: The method of any of Aspects 35-40, wherein the communications are channel state information (CSI) reference signals (CSI-RSs) or CSI interference measurement resources.

Aspect 42: The method of Aspect 41, further comprising aligning a periodicity and offset of the CSI-RS s with downlink slots of a TDD pattern.

Aspect 43: The method of any of Aspects 35-42, wherein the communications are sounding reference signals (SRSs).

Aspect 44: The method of Aspect 43, further comprising aligning the SRSs with uplink slots of a TDD pattern.

Aspect 45: The method of any of Aspects 35-44, wherein the communications are scheduling requests.

Aspect 46: The method of any of Aspects 35-45, wherein the communications are channel state information reports or buffer status reports.

Aspect 47: The method of any of Aspects 35-46, wherein the communications are transmitted in physical uplink channel resources or received in physical downlink channel resources.

Aspect 48: The method of any of Aspects 35-47, wherein the communications are synchronization signal blocks (SSBs).

Aspect 49: The method of any of Aspects 35-48, wherein the communications are random access channel messages.

Aspect 50: The method of any of Aspects 35-49, wherein the communications are cross-link interference measurement resources.

Aspect 51: The method of any of Aspects 35-50, wherein the communications are signal strength or signal quality measurement resources.

Aspect 52: The method of any of Aspects 35-51, wherein the communications are paging messages.

Aspect 53: The method of any of Aspects 35-52, wherein the communications are system information blocks.

Aspect 54: The method of any of Aspects 35-53, further comprising aligning a resource timing among multiple multimedia traffic flows based at least in part on a common multiple quantity of multimedia traffic flows for a common outer cycle.

Aspect 55: A method of wireless communication performed by a network entity, comprising: transmitting a configuration for a periodicity of communication times that are evenly divided by or are multiples of a time division duplex (TDD) periodicity and that are based at least in part on a multimedia traffic periodicity; and transmitting or receiving communications at the communication times.

Aspect 56: The method of Aspect 55, wherein the communication times are based at least in part on a TDD pattern of granted resources.

Aspect 57: The method of any of Aspects 55-56, wherein the communication times are of a discontinuous reception (DRX) cycle.

Aspect 58: The method of Aspect 57, further comprising adjusting DRX offsets values such that DRX on-durations align with downlink slots of a TDD pattern.

Aspect 59: The method of Aspect 57, further comprising adjusting DRX offsets values such that DRX on-durations align with specific radio resource timings.

Aspect 60: The method of Aspect 57, further comprising adjusting DRX offsets values such that DRX on-durations align with outer configured grant or semi-persistent scheduling cycles.

Aspect 61: The method of any of Aspects 55-60, wherein the communications are channel state information (CSI) reference signals (CSI-RSs) or CSI interference measurement resources.

Aspect 62: The method of Aspect 61, further comprising aligning a periodicity and offset of the CSI-RS s with downlink slots of a TDD pattern.

Aspect 63: The method of any of Aspects 55-62, wherein the communications are sounding reference signals (SRSs).

Aspect 64: The method of Aspect 63, further comprising aligning the SRSs with uplink slots of a TDD pattern.

Aspect 65: The method of any of Aspects 55-64, wherein the communications are scheduling requests.

Aspect 66: The method of any of Aspects 55-65, wherein the communications are channel state information reports or buffer status reports.

Aspect 67: The method of any of Aspects 55-66, wherein the communications are transmitted in physical uplink channel resources or received in physical downlink channel resources.

Aspect 68: The method of any of Aspects 55-67, wherein the communications are synchronization signal blocks (SSBs).

Aspect 69: The method of any of Aspects 55-68, wherein the communications are random access channel messages.

Aspect 70: The method of any of Aspects 55-69, wherein the communications are cross-link interference measurement resources.

Aspect 71: The method of any of Aspects 55-70, wherein the communications are signal strength or signal quality measurement resources.

Aspect 72: The method of any of Aspects 55-71, wherein the communications are paging messages.

Aspect 73: The method of any of Aspects 55-72, wherein the communications are system information blocks.

Aspect 74: The method of any of Aspects 55-73, further comprising aligning a resource timing among multiple multimedia traffic flows based at least in part on a common multiple quantity of multimedia traffic flows for a common outer cycle.

Aspect 75: An apparatus for wireless communication at a device, comprising a processor; memory coupled with the processor; and instructions stored in the memory and executable by the processor to cause the apparatus to perform the method of one or more of Aspects 1-74.

Aspect 76: A device for wireless communication, comprising a memory and one or more processors coupled to the memory, the one or more processors configured to perform the method of one or more of Aspects 1-74.

Aspect 77: An apparatus for wireless communication, comprising at least one means for performing the method of one or more of Aspects 1-74.

Aspect 78: A non-transitory computer-readable medium storing code for wireless communication, the code comprising instructions executable by a processor to perform the method of one or more of Aspects 1-74.

Aspect 79: A non-transitory computer-readable medium storing a set of instructions for wireless communication, the set of instructions comprising one or more instructions that, when executed by one or more processors of a device, cause the device to perform the method of one or more of Aspects 1-74.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a configuration for a periodicity of communication times that are factors of a time division duplex (TDD) periodicity, wherein the communication times are based at least in part on a multimedia traffic periodicity; and
transmitting or receiving communications at the communication times.

2. The method of claim 1, wherein the communication times are based at least in part on a TDD pattern of granted resources.

3. The method of claim 1, wherein the communication times are of a discontinuous reception (DRX) cycle.

4. The method of claim 3, further comprising adjusting DRX offsets values such that DRX on-durations align with downlink slots of a TDD pattern.

5. The method of claim 3, further comprising adjusting DRX offsets values such that DRX on-durations align with configured grant or semi-persistent scheduling cycles.

6. The method of claim 1, wherein the communications are channel state information (CSI) reference signals (CSI-RS s) or CSI interference measurement resources, the method further comprising aligning a periodicity and offset of the CSI-RSs with downlink slots of a TDD pattern associated with the TDD periodicity.

7. The method of claim 1, wherein the communications are sounding reference signals (SRSs), the method further comprising aligning the SRSs with uplink slots of a TDD pattern associated with the TDD periodicity.

8. The method of claim 1, wherein the communications are at least one of:
scheduling requests,
channel state information reports,
buffer status reports,
synchronization signal blocks (SSBs),
random access channel messages,
cross-link interference measurement resources,
signal strength or signal quality measurement resources,
paging messages, or
system information blocks.

9. The method of claim 1, wherein the communications are transmitted in physical uplink channel resources or received in physical downlink channel resources.

10. The method of claim 1, further comprising aligning a resource timing among multiple multimedia traffic flows based at least in part on a common multiple quantity of multimedia traffic flows for a common outer cycle.

11. The method of claim 1, wherein the one or more communications are configured grant communications or semi-persistent scheduling communication, wherein the configuration indicates that the one or more communication times are included in a next available slot in a TDD pattern associated with the TDD periodicity.

12. The method of claim 1, wherein the multimedia traffic periodicity is a rational number.

13. A method of wireless communication performed by a network entity, comprising:
transmitting a configuration for a periodicity of communication times that are factors of a time division duplex (TDD) periodicity, wherein the communication times are based at least in part on a multimedia traffic periodicity; and
transmitting or receiving communications at the communication times.

14. The method of claim 13, wherein the communication times are based at least in part on a TDD pattern of granted resources.

15. The method of claim 13, wherein the communication times are of a discontinuous reception (DRX) cycle.

16. The method of claim 13, wherein the communications are channel state information (CSI) reference signals (CSI-RS s) or CSI interference measurement resources, the method further comprising aligning a periodicity and offset of the CSI-RSs with downlink slots of a TDD pattern.

17. The method of claim 13, wherein the communications are sounding reference signals (SRSs), the method further comprising aligning the SRSs with uplink slots of a TDD pattern.

18. The method of claim 13, wherein the multimedia traffic periodicity is a rational number.

19. A user equipment (UE) for wireless communication, comprising:
one or more memories; and
one or more processors, coupled to the one or more memories, configured to:
receive a configuration for a periodicity of communication times that are evenly divided by or are multiples of a time division duplex (TDD) periodicity, wherein the communication times are based at least in part on a multimedia traffic periodicity; and
transmit or receive communications at the communication times.

20. The UE of claim 19, wherein the communication times are based at least in part on a TDD pattern of granted resources.

21. The UE of claim 19, wherein the communications are channel state information (CSI) reference signals (CSI-RS s) or CSI interference measurement resources, and wherein the one or more processors are further configured to align a periodicity and offset of the CSI-RS s with downlink slots of a TDD pattern.

22. The UE of claim 19, wherein the communications are sounding reference signals (SRSs), and wherein the one or more processors are configured to align the SRSs with uplink slots of a TDD pattern.

23. The UE of claim 19, wherein the communications are at least one of:
scheduling requests,
channel state information reports,
buffer status reports,
synchronization signal blocks (SSBs),
random access channel messages,
cross-link interference measurement resources,
signal strength or signal quality measurement resources,
paging messages, or
system information blocks.

24. The UE of claim 19, wherein the one or more processors, to transmit or receive the communications, are configured to:
transmit the one or more communications in physical uplink channel resources; or
receive the one or more communications in physical downlink channel resources.

25. The UE of claim 19, wherein the one or more processors are configured to align a resource timing among multiple multimedia traffic flows based at least in part on a common multiple quantity of multimedia traffic flows for a common outer cycle.

26. The UE of claim 19, wherein the one or more communications are configured grant communications or semi-persistent scheduling communication, and wherein the configuration indicates that the one or more communication times are included in a next available slot in a TDD pattern associated with the TDD periodicity.

27. The UE of claim 19, wherein the multimedia traffic periodicity is a rational number.

28. A network entity for wireless communication, comprising:
one or more memories; and
one or more processors, coupled to the one or more memories, configured to:
transmit a configuration for a periodicity of communication times that are factors of a time division duplex (TDD) periodicity, wherein the communication times are based at least in part on a multimedia traffic periodicity; and
transmit or receive communications at the communication times.

29. The network entity of claim 28, wherein the communication times are based at least in part on a TDD pattern of granted resources.

30. The network entity of claim 28, wherein the one or more processors are configured to align a resource timing among multiple multimedia traffic flows based at least in part on a common multiple quantity of multimedia traffic flows for a common outer cycle.
